(19) United States
(12) Patent Application Publication
(10) Pub. No.: US 2026/0323367 A1
(43) Pub. Date: Oct. 15, 2026

(54) ELECTRONIC DEVICE FOR PERFORMING CALL AND METHOD FOR THE SAME

(71) Applicant: Samsung Electronics Co., Ltd., Suwon-si (KR)

(72) Inventors: Kyujae JANG, Suwon-si (KR); Sangmin YE, Suwon-si (KR); Hyunkyung JO, Suwon-si (KR); Jaemoon CHA, Suwon-si (KR)

(21) Appl. No.: 19/644,608

(22) Filed: Apr. 10, 2026

Related U.S. Application Data
(63) Continuation of application No. PCT/KR2026/005218, filed on Apr. 6, 2026.

(30) Foreign Application Priority Data
Apr. 10, 2025 (KR) 10-2025-0046736
Apr. 23, 2025 (KR) 10-2025-0053119

(51) Int. Cl. H04W 28/02; H04R 25/00

(52) U.S. Cl. CPC H04W 28/0236; H04R 25/554

(57) ABSTRACT

An electronic device is provided. The electronic device includes a plurality of antennas, communication circuitry electrically connected to the plurality of antennas, memory storing a computer program including instructions, and at least one processor, wherein the instructions, when executed individually or collectively by the at least one processor, cause the electronic device to detect an activation of call service while transmitting, to a base station, respective signals including different parts of data to be transmitted via the plurality of antennas, and when hearing aid compatibility mode is activated on the electronic device and the base station supports voice priority mode in which packets related to the call service are transmitted with higher priority than other packets, transmit the packets related to the call service via at least one antenna among the plurality of antennas.

### CROSS-REFERENCE TO RELATED APPLICATIONS

This application is a continuation application, claiming priority under 35 U.S.C. § 365(c), of an International application No. PCT/KR2026/005218, filed on Apr. 6, 2026, which is based on and claims the benefit of a Korean patent application number 10-2025-0046736, filed on Apr. 10, 2025, in the Ministry of Intellectual Property (MOIP), and of a Korean patent application number 10-2025-0053119, filed on Apr. 23, 2025, in the Ministry of Intellectual Property (MOIP), the disclosure of each of which is incorporated by reference herein in its entirety.

### TECHNICAL FIELD

The disclosure relates to an electronic device and a method for operating the electronic device. More particularly, the disclosure relates to a technology for performing a call.

### BACKGROUND ART

In order to meet the demand for wireless data traffic increasing since the commercialization of fourth generation (4G) communication systems, efforts to develop an improved fifth generation (5G) communication system or a pre-5G communication system are being made. For this reason, 5G or pre-5G communication systems are also referred to as beyond 4G communication systems or post-long term evolution (LTE) systems. To achieve a high data transmission rate, 5G communication systems are being considered for implementation not only in bands used in LTE (6GHz or lower bands) but also in super high frequency (millimeter wave (mmWave)) bands (e.g., 6GHz or higher bands). In 5G communication systems, beamforming, massive multiple-input multiple-output (MIMO), full dimensional MIMO (FD-MIMO), array antenna, analog beamforming, and large scale antenna technologies are being discussed.

When equipped with a plurality of antennas, an electronic device may support various signal transmission schemes via the plurality of antennas. According to an example, signal transmission schemes via the plurality of antennas may include uplink multiple-input multiple-output (UL-MIMO) or transmit (Tx) diversity. The UL-MIMO may refer to a transmission scheme in which respective signals including different parts of data to be transmitted are output via the plurality of antennas. The Tx diversity may refer to a transmission scheme in which respective signals including the same data are output via the plurality of antennas.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

When outputting signals via a plurality of antennas, an electronic device may output signals via a channel established (or configured) between the electronic device and the base station. According to an example, the channel established between the electronic device and the base station may be a time division duplex channel. The time division duplex channel may refer to a channel implemented such that the time (or time slot) to transmit signals in a particular frequency band and the time (or time slot) to receive signals are distinguished. When performing UL-MIMO via a time division duplex channel, the electronic device may output signals via a plurality of antennas for a time allocated for signal transmission, and may receive signals from the base station for a time allocated for signal reception.

In order to output signals, the electronic device may supply power to components (e.g., amplifiers) related to signal output, and a magnetic field may be generated around the electronic device by the signal output. The strength of a magnetic field may be associated with a change in the signal strength, and according to an example, the strength of the magnetic field may increase in proportion to the change in the signal strength.

The magnetic field of increased strength may cause interference in an external electronic device existing near the electronic device 101. According to an example, the external electronic device may be a wearable device (e.g., a hearing aid) worn by the user of the electronic device. The user of the electronic device may perform a call using the electronic device while wearing the wearable device. When the electronic device transmits call-related packets (e.g., packets including at least a part of data corresponding to the user's voice) to the base station via the time division duplex channel, signals including the call-related packets may undergo relatively large changes in signal strength, thereby causing interference in the wearable device. Interference caused in the wearable device may degrade the performance of the wearable device.

Aspects of the disclosure are to address at least the above-mentioned problems and/or disadvantages and to provide at least the advantages described below. Accordingly, an aspect of the disclosure is to provide an electronic device and a method for performing a call.

Additional aspects will be set forth in part in the description which follows and, in part, will be apparent from the description, or may be learned by practice of the presented embodiments.

### Solution to Problem

In accordance with an aspect of the disclosure, an electronic device is provided. The electronic device includes a plurality of antennas, communication circuitry electrically connected to the plurality of antennas, memory storing a computer program including instructions, and at least one processor, wherein the instructions, when executed individually or collectively by the at least one processor, cause the electronic device to detect an activation of call service while transmitting, to a base station, respective signals including different parts of data to be transmitted via the plurality of antennas, and when a hearing aid compatibility mode is activated on the electronic device and the base station supports a voice priority mode in which packets related to the call service are transmitted with higher priority than other packets, transmit the packets related to the call service via at least one antenna among the plurality of antennas.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include detecting an activation of call service while transmitting, to a base station, respective signals including different parts of data to be transmitted via the plurality of antennas, and when a hearing aid compatibility mode is activated on the electronic device and the base station supports a voice priority mode in which packets related to the call service are transmitted with higher priority than other packets, transmitting the packets related to the call service via at least one antenna among the plurality of antennas.

In accordance with another aspect of the disclosure, a method for operating an electronic device is provided. The method includes detecting an activation of call service while transmitting, to a base station, respective signals including different parts of data to be transmitted via the plurality of antennas, and when a hearing aid compatibility mode is activated on the electronic device and the base station supports a voice priority mode in which packets related to the call service are transmitted with higher priority than other packets, transmitting the packets related to the call service via at least one antenna among the plurality of antennas.

In accordance with another aspect of the disclosure, an electronic device is provided. The electronic device includes a plurality of antennas, communication circuitry electrically connected to the plurality of antennas, memory storing a computer program including instructions, and at least one processor, wherein the instructions, when executed individually or collectively by the at least one processor, cause the electronic device to detect an activation of call service while transmitting, to a base station, respective signals including different parts of data to be transmitted via the plurality of antennas, when a hearing aid compatibility mode is activated on the electronic device and the base station supports configuration of cellular communication based on user equipment (UE) assistance information transmitted by the electronic device, transmit, to the base station, the UE assistance information for switching the electronic device from a first mode in which the electronic device outputs respective signals including different parts of the data to be transmitted via the plurality of antennas to a second mode in which the electronic device outputs the data to be transmitted via one of the plurality of antennas, and transmit packets related to the call service via at least one antenna among the plurality of antennas.

### Advantageous Effectsof invention

An electronic device and a method for operating the electronic device according to an embodiment, in case that a hearing aid compatibility mode is activated in the electronic device, and in case that the base station supports a voice priority mode in which call-related packets are transmitted and/or received with higher priority than other packets, switch from a first mode in which respective signals including different parts of the data to be transmitted are transmitted via the plurality of antennas to a second mode in which signals including the data to be transmitted are transmitted via at least one of the plurality of antennas. The transition from the first mode to the second mode reduces the number of layers of data streams transmitted by the electronic device to the base station, and reduces the number of antennas used to transmit signals, thereby reducing the magnitude of the magnetic field generated according to a change in signal output. Therefore, the electronic device reduces the degree of interference experienced by a wearable device (or a hearing aid) adjacent to the electronic device due to signals output from the electronic device.

An electronic device and a method for operating the electronic device according to an embodiment, in case that a hearing aid compatibility mode is activated in the electronic device, and in case that the base station supports a change in configuration of wireless cellular communication based on UE assistance information, transmit, to the base station, UE assistance information in which the maximum number of data layers supportable by the electronic device is configured to have a specified size. Based on the UE assistance information, the base station switches from a first mode in which respective signals including different parts of the data to be transmitted are transmitted via the plurality of antennas to a second mode in which signals including the data to be transmitted are transmitted via at least one of the plurality of antennas. The transition from the first mode to the second mode reduces the number of layers of data streams transmitted by the electronic device to the base station, and reduces the number of antennas used to transmit signals, thereby reducing the magnitude of the magnetic field generated according to a change in signal output. Therefore, the electronic device reduces the degree of interference experienced by a wearable device (or a hearing aid) adjacent to the electronic device due to signals output from the electronic device.

Other aspects, advantageous, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device for supporting at least one network communication according to an embodiment of the disclosure;

FIG. 2A is a diagram illustrating an example in which an electronic device transmits signals to a base station via a plurality of antennas according to an embodiment of the disclosure;

FIG. 2B is a graph illustrating a current change according to a signal transmission in case that an electronic device transmits signals to a base station via a time division duplex channel according to an embodiment of the disclosure;

FIG. 3 is a block diagram of an electronic device according to an embodiment of the disclosure;

FIG. 4 is a diagram illustrating an example in which an electronic device transmits call-related packets via at least one antenna among a plurality of antennas in case that the base station supports a voice priority mode according to an embodiment of the disclosure;

FIG. 5 is a diagram illustrating an example in which an electronic device transmits call-related packets via at least one antenna among a plurality of antennas in case that the base station supports no voice priority mode according to an embodiment of the disclosure;

FIG. 6 is a diagram illustrating an example in which an electronic device transmits call-related packets via at least one antenna among a plurality of antennas in case that the base station supports configuration of cellular communication based on UE assistance information according to an embodiment of the disclosure;

FIG. 7 is a diagram illustrating an example in which an electronic device transmits call-related packets via at least one antenna among a plurality of antennas in case that the base station supports no configuration of cellular communication based on UE assistance information according to an embodiment of the disclosure;

FIG. 8A is a diagram illustrating an example in which an electronic device transmits signals including different parts of data via a time division duplex channel according to an embodiment of the disclosure;

FIG. 8B is a diagram illustrating an example in which an electronic device transmits signals including data via a time division duplex channel according to an embodiment of the disclosure;

FIG. 8C is a diagram illustrating an example in which an electronic device transmits signals via a time division duplex channel and a frequency division duplex channel according to an embodiment of the disclosure;

FIG. 8D is a diagram illustrating an example in which an electronic device transmits signals via a frequency division duplex channel according to an embodiment of the disclosure;

FIG. 9 is an operation flowchart illustrating a method for operating an electronic device according to an embodiment of the disclosure;

FIG. 10 is an operation flowchart illustrating a method for operating an electronic device according to an embodiment of the disclosure;

FIG. 11 is an operation flowchart illustrating a method for operating an electronic device according to an embodiment of the disclosure; and

FIG. 12 is an operation flowchart illustrating a method for operating an electronic device according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

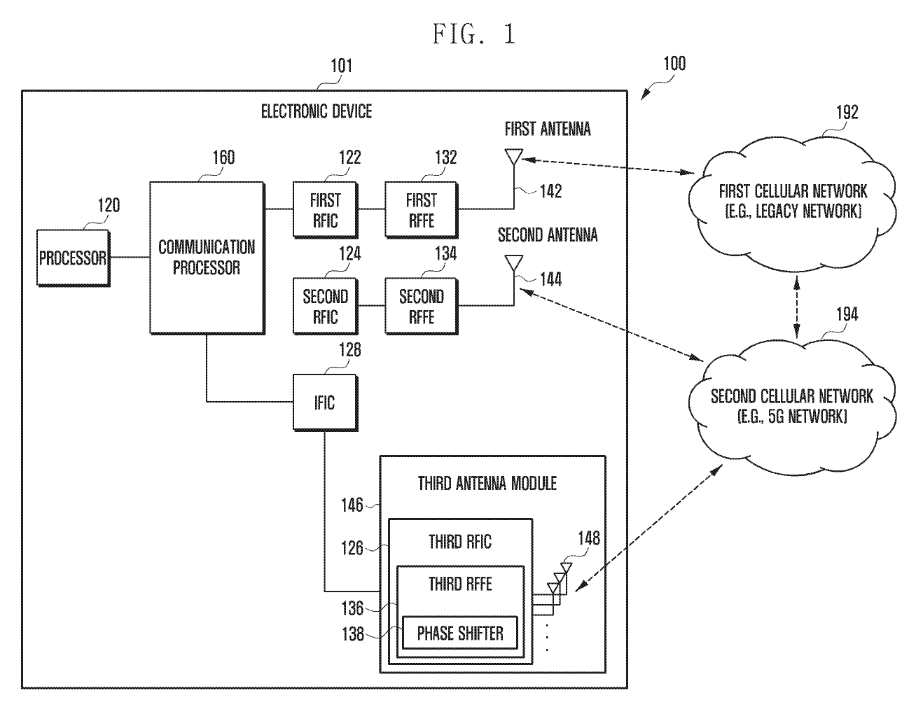

FIG. 1 is a block diagram of an electronic device for supporting at least one network communication according to an embodiment of the disclosure. As illustrated in block diagram 100, an electronic device 101 supports at least one network communication and may comprise, for example, a portable device (e.g., a smartphone, a tablet personal computer (PC), a portable multimedia device, a portable medical device, a camera, or a wearable device), a computer, or a home appliance. The electronic device 101 according to an embodiment of the disclosure is not limited to the above-described devices.

Referring to FIG. 1, the electronic device 101 may comprise a processor 120, a communication processor 160, a first radio frequency integrated circuit (RFIC) 122, a second RFIC 124, a third RFIC 126, an intermediate frequency integrated circuit (IFIC) 128, a first radio frequency front end (RFFE) 132, a second RFFE 134, a third RFFE 136, a phase shifter 138, a plurality of antennas 148, a first antenna 142, a second antenna 144 and/or an antenna module 146.

The antenna module 146 may comprise a third RFIC 126 and/or a plurality of antennas 148. The third RFIC 126 may comprise a third RFFE 136 including a phase shifter 138, but the disclosure is not limited thereto. The third RFIC 126, the third RFFE 136, the phase shifter 138, and/or the plurality of antennas 148 may be implemented to be included in or mounted on a separate module or substrate.

The processor 120 may be implemented, for example, as an application processor and may execute an application stored in the electronic device 101. The processor 120 and the communication processor 160 may transmit and/or receive data through an interface. The processor 120 may provide at least a portion of data generated by the application to the communication processor 160. The communication processor 160 may provide at least a portion of data received from a network (e.g., a first cellular network 192 and/or a second cellular network 194) to the processor 120, and the processor 120 may utilize the received data to execute the application.

The communication processor 160 may be implemented as a single chip (or a single package) together with the processor 120, depending on implementations, but it is only of an example and may be implemented as independent hardware. When the communication processor 160 is implemented as a chip (or package), the chip (or package) may include a storage device (e.g., memory) storing protocol information for communication with a legacy network (e.g., long term evolution (LTE) protocol information), protocol information for communication with a 5G network (e.g., New Radio (NR) protocol information), and/or protocol information for communication with a beyond 5G communication network (e.g., sixth generation (6G) network). For example, the communication processor 160 may use a plurality of protocol stacks to perform multiple radio access technology-dual connectivity (MR-DC) or dual subscriber identification module (SIM) service. The communication processor 160 may support establishment of a communication channel in a band to be used for wireless communication with the first cellular network 192, and legacy network communications through the established communication channel. According to various embodiments, the first cellular network 192 may be a legacy network including second generation (2G), third generation (3G), fourth generation (4G), and/or LTE networks. The communication processor 160 may support establishment of a communication channel corresponding to a designated band (e.g., frequency range (FR) 1 (e.g., 410 megahertz (MHz) to 7.125 gigahertz (GHz), although not limited thereto) (or sub 6), and/or FR 2 (e.g., 24.25 GHz to 71 GHz, although not limited thereto) (or above 6), amongst bands to be used for wireless communication with the second cellular network 194, and 5G network communications through the established communication channel. The second cellular network 194 may be, for example, a 5G network, but is not limited thereto. For example, the second cellular network 194 may be a beyond 5G communication network (e.g., 6G network). The communication processor 160 may operate based on information (or instructions) associated with an LTE (e.g., evolved universal mobile telecommunication system (UMTS) terrestrial radio access network (E-UTRA), evolved packet core (EPC), and/or evolved packet system (EPS), although not limited thereto) protocol stack, stored in internal memory (or accessible memory). The communication processor 160 may operate based on information (or instructions) associated with a 5G (e.g., NR, 5th generation core (5GC), and/or 5th generation system (5GS), although not limited thereto) protocol stack, stored in internal memory (or accessible memory). The communication processor 160 may generate a baseband signal based on data from the processor 120. The communication processor 160 may provide the processor 120 with data obtained by processing the baseband signal received from the first RFIC 122, the second RFIC 124, and/or the IFIC 128. The electronic device 101 may perform communication based on dual connectivity. For example, the electronic device 101 may perform communications using an LTE network and a 5G network, based on heterogeneous radio access technology (RAT), for example, E-UTRA NR dual connectivity (ENDC). For example, the electronic device 101 (e.g., the communication processor 160) may perform dual connectivity communication based on FR1 and FR2 of NR, which may be one RAT. Meanwhile, there is no limitation in the type of dual connectivity, and at least some of the above-described components may be implemented not to be included in the electronic device 101, depending upon the type of the dual connectivity.

For transmission, the first RFIC 122 may convert a baseband signal generated by the communication processor 160 into a radio frequency (RF) signal in a first frequency band (e.g., about 700 MHz to about 3 GHz). For reception, the first RFFE 132 may receive an RF signal in the first frequency band via the first antenna 142 and preprocess the received RF signal to provide the preprocessed RF signal to the first RFIC 122. The first RFIC 122 may convert the preprocessed RF signal into a baseband signal so as to be processed by the communication processor 160.

For transmission, the second RFIC 124 may convert a baseband signal generated by the communication processor 160 into an RF signal in a second frequency band (for example, FR 1 (e.g., a frequency band of about 7.125 GHz or less)). For reception, the second RFFE 134 may receive an RF signal in the second frequency band via an antenna (e.g., the second antenna 144) and preprocess the received RF signal to provide the preprocessed signal to the second RFIC 124. The second RFIC 124 may convert the preprocessed RF signal in the second frequency band into a baseband signal so as to be processed by the communication processor 160. The first RFIC 122 and the second RFIC 124 may be implemented as two or more independent chips (or a plurality of packages), or may be implemented as a single chip (or a single package). The first RFIC 122, the second RFIC 124, the first RFFE 132, and/or the second RFFE 134 may include a plurality of power amplifiers (PAs), low noise amplifiers (LNAs), filters, multiplexers, and/or switches, for supporting a plurality of RF paths (e.g., an RF transmit path and/or an RF receive path).

For transmission, the third RFIC 126 may convert a baseband signal generated by the communication processor 160 into an RF signal in a third frequency band (e.g., a frequency band of about 24.25 GHz or more). For reception, the third RFFE 136 may receive an RF signal in the third frequency band through an antenna (e.g., a plurality of antennas 148) and preprocess the received RF signal. The third RFIC 126 and/or the IFIC 128 may convert the preprocessed RF signal in the third frequency band into a baseband signal so as to be processed by the communication processor 160. According to an embodiment, the third RFFE 136 may be configured as a part of the third RFIC 126. In various embodiments, the third RFIC 126 may transmit and/or receive a signal to and/or from the communication processor 160. For example, when communication is performed based on the dual connectivity of FR1 and FR2, the second RFIC 124 and the second RFFE 134 may be used to process signals in the FR1 band, and the third RFIC 126 and the IFIC 128 may be used to process signals in the FR2 band, although the disclosure is not limited thereto.

According to an embodiment, the electronic device 101 may include the IFIC 128 separately from the third RFIC 126 or as at least part thereof. For example, the IFIC 128 may convert a baseband signal generated by the communication processor 160 into an RF signal in an intermediate frequency band (e.g., about 9 GHz to about 11 GHz) (hereinafter, referred to as ‘IF signal’) and then may transfer the IF signal to the third RFIC 126. The third RFIC 126 may convert the IF signal into an RF signal in a third frequency band. For reception, the third RFIC 126 may receive the RF signal in the third frequency band via an antenna (e.g., a plurality of antennas 148) and then convert the received RF signal into an IF signal to provide the converted signal to the IFIC 128. The IFIC 128 may convert the IF signal into a baseband signal so that the communication processor 160 may process the signal. In various embodiments, the IFIC 128 may transmit and/or receive a signal to and/or from the communication processor 160. The RFICs (122, 124, 126) and/or the IFIC 128 may include at least one mixer (e.g., a mixer performing up-conversion of frequency and/or a mixer performing down-conversion of frequency).

A plurality of antennas 148 may be formed as an antenna array including a plurality of antenna elements capable of being used for beamforming. In such a circumstance, the third RFIC 126, for example, as a part of the third RFFE 136, may include a plurality of phase shifters 138 corresponding to the plurality of antenna elements. For transmission, the plurality of phase shifters 138 may shift a phase of each RF signal in the third frequency band to be transmitted to the outside (e.g., a base station of a 5G network) of the electronic device 101 through an antenna element corresponding to each of the plurality of phase shifters 138. For reception, the plurality of phase shifters 138 may shift a phase of each RF signal in the third frequency band received from the outside into the same phase or substantially the same phase through an antenna element corresponding to each of the plurality of phase shifters 138. According to an embodiment, the electronic device 101 may include a plurality of antenna modules 146. The electronic device 1101) may selectively use some of the plurality of antenna modules 146 or may use the entirety of the plurality of antenna modules 146.

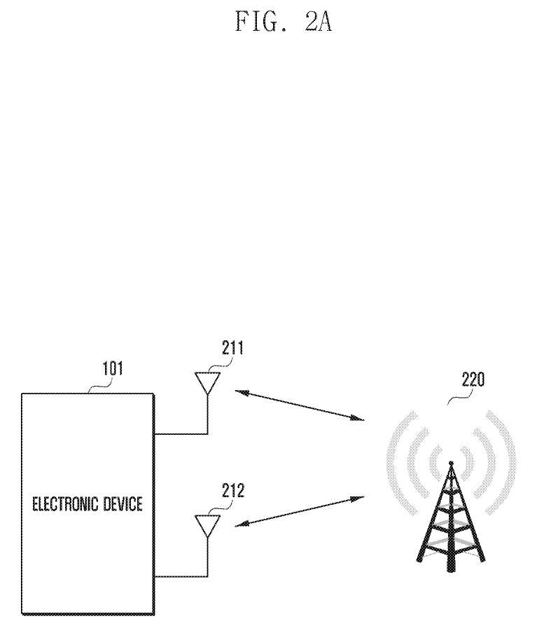

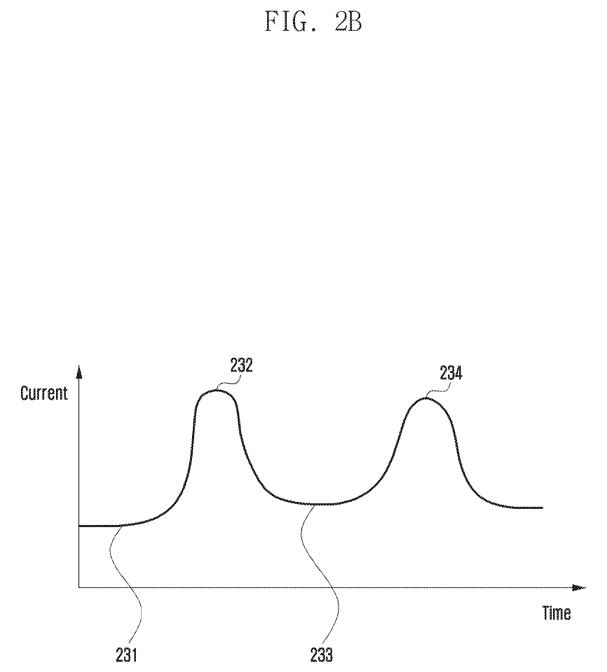

FIG. 2A is a diagram illustrating an example in which an electronic device transmits signals to a base station via a plurality of antennas according to an embodiment of the disclosure.

The electronic device (e.g., the electronic device 101 in FIG. 1) may transmit and/or receive signals to/from a base station 220 via a first antenna 211 (e.g., the first antenna 142, the second antenna 144, and/or a plurality of antennas 148 in FIG. 1) and a second antenna 212 (e.g., the first antenna 142, the second antenna 144, and/or a plurality of antennas 148 in FIG. 1).

The base station 220 may be an entity supporting cellular wireless communication and may be included in a cellular network. The base station 220 may receive data to be transmitted to the electronic device 101 from the core network of the cellular network (not illustrated), and then transmit the data to the electronic device 101 via a channel established (or generated) between the electronic device 101 and the base station 220. The base station 220 may receive data transmitted by the electronic device 101 and then transmit the data to the core network.

The electronic device 101 may support various signal transmission schemes via a plurality of antennas. According to an example, the signal transmission schemes via a plurality of antennas may include uplink multiple-input multiple-output (UL-MIMO) or Tx diversity. The UL-MIMO may refer to a transmission scheme in which respective signals including different parts of data to be transmitted are output via a plurality of antennas. The Tx diversity may refer to a transmission scheme in which respective signals including the same data are output via a plurality of antennas.

The electronic device 101 may perform cellular wireless communication, based on a radio resource control (RRC) reconfiguration message received from the base station 220. According to an example, the electronic device 101 may receive an RRC reconfiguration message including a configuration related to uplink multiple-input multiple-output (UL-MIMO), in case that the base station 220 (or the cellular network) supports UL-MIMO. According to an example, the configuration related to UL-MIMO may include at least one of whether the UL-MIMO is activated, the number of antennas which may be used by the electronic device 101 to transmit signals to the base station 220, or the number of layers (Tx layers) of data to be transmitted by the electronic device 101 to the base station 220.

According to an example, the electronic device 101 may receive an RRC reconfiguration message including a configuration related to UL-MIMO from the base station 220, and may transmit signals via a plurality of antennas 211 and 212, based on the configuration related to UL-MIMO. In case that the electronic device 101 performs UL-MIMO, data included in a signal output via the first antenna 211 and data included in a signal output via the second antenna 212 may be different from each other. The electronic device 101 may improve the data transmission rate (or throughput) by transmitting respective signals including different parts of data to be transmitted to the base station 220 via a plurality of antennas 211 and 212.

The electronic device 101 may perform cellular wireless communication, based on the RRC reconfiguration message received from the base station 220. According to an example, the electronic device 101 may receive an RRC reconfiguration message including a configuration related to Tx diversity, in case that the base station 220 (or the cellular network) supports Tx diversity. According to an example, the configuration related to Tx diversity may include whether the Tx diversity is activated or not, and the number of antennas that the electronic device 101 may use to transmit signals to the base station 220.

According to an example, the electronic device 101 may receive, from the base station 220, an RRC reconfiguration message including a configuration related to Tx diversity, and transmit signals via a plurality of antennas 211 and 212, based on the configuration related to Tx diversity. In case that the electronic device 101 performs Tx diversity, data included in a signal output via the first antenna 211 and data included in a signal output via the second antenna 212 may be identical to each other. The electronic device 101 may improve the data transmission success rate and substantially increase the coverage of the base station 220 by transmitting respective signals including the same data to the base station 220 via a plurality of antennas 211 and 212.

FIG. 2B is a graph illustrating a change in current according to signal transmission in case that an electronic device transmits a signal to a base station via a time division duplex channel according to an embodiment of the disclosure.

The electronic device (e.g., the electronic device 101 in FIG. 2A) may perform UL-MIMO via a time division duplex (TDD) channel. The time division duplex channel may refer to a channel implemented such that the time (or time slot) to transmit signals in a specific frequency band and the time (or time slot) to receive signals are distinguished. In case that the electronic device 101 performs UL-MIMO via a time division duplex channel, the electronic device 101 may output signals via a plurality of antennas during a time allocated for signal transmission, and may receive signals from the base station (e.g., the base station 220 in FIG. 2A) during a time allocated for signal reception.

FIG. 2B is a diagram illustrating the strength (or current) of a signal that is output while the electronic device 101 performs UL-MIMO via a time division duplex channel. Referring to FIG. 2B, the signal strength during the time 231 or 233 allocated for the electronic device 101 to receive signals from the base station 220 may be relatively smaller than the signal strength during the time 232 or 234 allocated for the electronic device 101 to transmit signals to the base station 220.

Although not illustrated in FIG. 2B, in case that the electronic device 101 performs cellular communication (or UL-MIMO) via a frequency division duplex channel, the electronic device 101 may transmit signals to the base station 220 via a frequency band configured to transmit signals to the base station 220. In case that the electronic device 101 outputs signals via a frequency division duplex channel, there may be no time-based element that limits signal output, and changes in strength of signals output by the electronic device 101 may thus be smaller than changes in strength of signals output by the electronic device 101 via a time division duplex channel.

In order to output signals, the electronic device 101 may apply power to components (e.g., amplifiers) related to signal output, and a magnetic field may be generated around the electronic device 101 by the signal output. The strength of the magnetic field may be associated with a change in signal strength, and according to an example, the strength of the magnetic field may be proportional to the change in signal strength.

In case that the strength of the magnetic field increases, the magnetic field may interfere with an external electronic device existing near the electronic device 101. According to an example, the external electronic device may be a wearable device (e.g., a hearing aid) worn by the user of the electronic device 101. The user of the electronic device 101 may perform a call using the electronic device 101 while wearing the wearable device. In case that the electronic device 101 transmits a call-related packet (e.g., a packet including at least a part of data corresponding to the user’s voice) to the base station 220 via a time division duplex channel, the change in strength of the signal including the packet related to the call may be relatively large, thereby interfering with the wearable device. The interference incurred in the wearable device may degrade the performance of the wearable device.

Moreover, a product to be sold in a specific country may need to satisfy regulations (e.g., the 2019 standard of the hearing aid compatibility (HAC) mode T-coil test) related to interference caused in the hearing aid of the wearable device, and any increase in strength of the magnetic field may cause the electronic device 101 to fail to satisfy the above-described regulations.

Hereinafter, examples in which the electronic device 101 may reduce the strength of a magnetic field generated while operating in a UL-MIMO mode will be described.

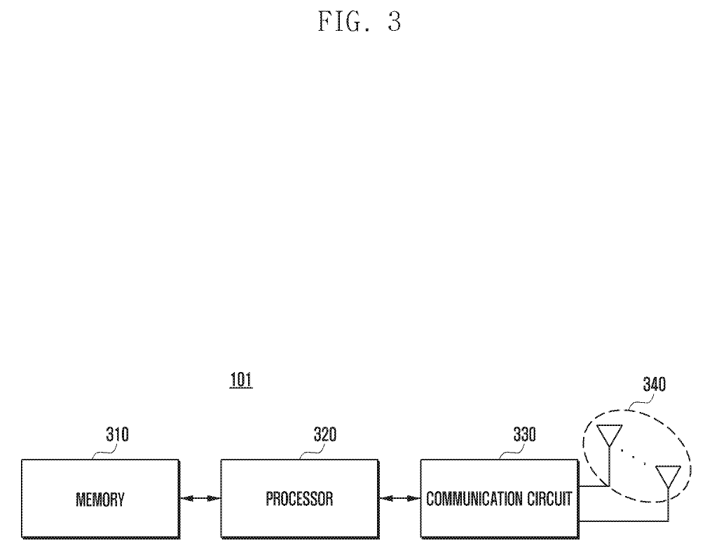

FIG. 3 is a block diagram of an electronic device according to an embodiment of the disclosure.

Referring to FIG. 3, the electronic device 101 may include memory 310, a processor 320 (e.g., the communication processor 160 in FIG. 1), a communication circuitry 330 (e.g., the first RFIC 122, the second RFIC 124, and the third RFIC 126 in FIG. 1), and/or a plurality of antennas 340 (e.g., the first antenna 142, the second antenna 144, and/or the plurality of antennas 148 in FIG. 1).

According to an example, the processor 320 may perform various operations for wireless communication on a cellular network. The processor 320 may establish a communication channel in a band to be used for wireless communication with the cellular network and support wireless communication via the established communication channel. Wireless communication on the cellular network may be referred to as cellular communication. The cellular communication may include at least one of third-generation cellular communication, fourth-generation cellular communication, and/or fifth-generation cellular communication. The processor 320 may be referred to as a communication processor.

According to an example, the memory 310 may store a computer program including instructions which may be executed by the processor 320. Operations of the processor 320 described below may be performed in accordance with execution of the instructions stored in the memory 310.

The communication circuitry 330 may perform various operations of processing signals received from the processor 320. For example, the communication circuitry 330 may perform a modulation operation regarding a signal received from the processor 320. For example, the communication circuitry 330 may perform a frequency modulation operation of converting a baseband signal to a radio frequency (RF) signal used for cellular communication. The communication circuitry 330 may perform a demodulation operation with regard to signals received via the plurality of antennas 340. For example, the communication circuitry 330 may perform a frequency demodulation operation of converting an RF signal to a baseband signal.

The communication circuitry 330 may include at least one RF chain for receiving a signal radiated from the outside via the plurality of antennas 340, or radiating a signal transmitted by the communication circuitry 330 via the plurality of antennas 340. For example, the RF chain may refer to a signal transfer path between the communication circuitry 330 and the plurality of antennas 340. The RF chain may include a front end module including various components (e.g., an amplifier, a switch, and/or a filter) that perform operations of amplifying signals received via the plurality of antennas 340 and/or signals transmitted by the communication circuitry 330, and filtering the amplified signals.

The electronic device 101 may support a signal transmission scheme using a plurality of antennas 340. The signal transmission scheme using the plurality of antennas 340 may include uplink multiple-input multiple-output (UL-MIMO) or Tx diversity. The UL-MIMO may refer to a transmission scheme in which respective signals including different parts of data to be transmitted are output via a plurality of antennas. The Tx diversity may refer to a transmission scheme in which signals each including the same data are output via a plurality of antennas.

The processor 320 may receive an RRC reconfiguration message from the base station 220, and perform cellular communication using the plurality of antennas 340, based on information related to a signal transmission method using the plurality of antennas 340, which is included in the RRC reconfiguration message.

According to an example, the processor 320 may receive an RRC reconfiguration message including a configuration related to uplink multiple-input multiple-output (UL-MIMO) in case that the base station 220 (or the cellular network) supports UL-MIMO. According to an example, the configuration related to UL-MIMO may include at least one of whether the UL-MIMO is activated, the number of antennas which may be used by the electronic device 101 to transmit signals to the base station 220, or the number of layers (Tx layers) of data to be transmitted by the electronic device 101 to the base station 220.

The processor 320 may receive an RRC reconfiguration message including a configuration related to UL-MIMO from the base station 220, and transmit signals via a plurality of antennas 340, based on the configuration related to UL-MIMO. In case that the electronic device 101 performs UL-MIMO, data included in a signal output via one of the plurality of antennas 340 and data included in a signal output via another of the plurality of antennas 340 may differ from each other. The processor 320 may improve the data transmission rate (or throughput) by transmitting respective signals including different parts of data to be transmitted to the base station 220 via the plurality of antennas 340.

The electronic device 101 performing UL-MIMO may support various modes according to the number of layers of data transmitted by the electronic device 101. According to an example, the number of layers may refer to the number of individual data streams transmitted in case that the electronic device 101 transmits a plurality of data streams via a plurality of antennas 340. According to an example, the description that the number of layers of data is two may mean that two data streams including different pieces of data may be transmitted via the plurality of antennas 340. A mode for transmitting at least two or more data layers may be defined as a first mode. For example, the first mode may be referred to as a spatially multiplexed dual layer (SMDL) for a mode of transmitting two data layers. A mode for transmitting one data layer may be referred to as a second mode (or spatially multiplexed single layer (SMSL)).

According to an example, the processor 320 may perform cellular wireless communication in a first mode (e.g., SMDL) that supports transmission of at least two or more data layers. The processor 320 may control the communication circuitry 330 to transmit signals including different pieces of data obtained by dividing data to be transmitted, according to the configured number of layers, to the base station 220 via the plurality of antennas 340.

The processor 320 may detect activation of a call service while performing cellular wireless communication in a first mode (e.g., SMDL) supporting transmission of at least or more two data layers.

According to an example, the processor 320 may detect activation of a call service according to execution of an application related to the call service. According to another example, the processor 320 may detect activation of a call service in response to receiving a signal (e.g., a paging message) indicating activation of a call service from the base station 220.

The processor 320 may identify whether a wearable device (e.g., a hearing aid) is adjacent to the electronic device 101 in response to detecting activation of a call service. Alternatively, the processor 320 may identify whether the wearable device (e.g., a hearing aid) is likely to be adjacent to the electronic device 101, in response to detecting activation of the call service. The wearable device may refer to various electronic devices that may possibly experience interference in operations of the wearable device by signals output by the electronic device 101 while the electronic device 101 performs a call service. Although a hearing aid is given as a representative example of the wearable device in the disclosure, the wearable device is not limited to a hearing aid, and may refer to various electronic devices that may possibly experience interference by signals output by the electronic device 101 while the electronic device 101 performs a call service.

For example, the processor 320 may identify whether a hearing aid compatibility mode is activated in the electronic device 101. Activation of the hearing aid compatibility mode in the electronic device 101 may indicate that the user of the electronic device 101 is wearing a hearing aid, and that the hearing aid is likely to be affected by signals output while a call service is performed using the electronic device 101.

In response to identifying that a hearing aid compatibility mode is activated in the electronic device 101, the processor 320 may perform an operation for reducing the magnitude of a magnetic field generated by output of signals via the plurality of antennas (or for reducing (or preventing) interference of a wearable device (e.g., a hearing aid)).

The processor 320 may identify whether the base station 220 supports a voice priority mode in which call-related packets are transmitted with higher priority than other packets. According to an example, the processor 320 may receive an RRC reconfiguration message from the base station 220 during a process of initially accessing the base station 220 (e.g., a process in which the electronic device 101 hands over from another base station to the base station 220) or a process of switching the RRC state (e.g., switching from an RRC idle state to an RRC connected state). The RRC reconfiguration message received from the base station 220 may include information indicating whether the base station 220 supports the voice priority mode. The voice priority mode may refer to a mode in which the base station 220 or the electronic device 101 preferentially processes transmission and/or reception of call-related packets, as compared to transmission and/or reception of other types of packets (e.g., packets including user data). The base station 220 supporting the voice priority mode may reduce the delay time of transmission and/or reception of call-related packets as compared to base stations not supporting the voice priority mode.

In case that the base station 220 supporting the voice priority mode receives a specific signal (e.g., information indicating that the hearing aid compatibility mode is activated) from the electronic device 101, the base station 220 may transmit one data layer to the electronic device 101, when transmitting call-related packets, even if the electronic device 101 is configured to operate in a mode of transmitting a data layers.

The processor 320 may identify whether the base station 220 supports the voice priority mode, based on the information indicating whether the voice priority mode is supported, which is included in the RRC reconfiguration message received from the base station 220.

In case that the hearing aid compatibility mode is activated in the electronic device 101, and in case that the base station 220 supports the voice priority mode in which call-related packets are transmitted and/or received with higher priority than other packets, the processor 320 may control the communication circuitry 330 to transmit call-related packets to the base station 220 via at least one of the plurality of antennas 340.

In order to transmit call-related packets to the base station 220 via at least one of the plurality of antennas 340, the processor 320 may reduce the number of layers of data streams transmitted to the base station 220. The reduced number of layers of data streams transmitted to the base station 220 may refer to a possible reduction in the number of antennas used by the electronic device 101 to transmit signals to the base station 220. Reducing the number of antennas used to transmit signals may reduce the magnitude of a magnetic field generated by a change in signal output. The reduced magnitude of the magnetic field may reduce the interference experienced by the wearable device due to signals output by the electronic device 101.

According to an example, in a situation in which the electronic device 101 performs UL-MIMO via a TDD channel, reducing the number of layers of data streams may reduce the change in strength of signals that are output, thereby reducing the magnitude of the magnetic field.

The processor 320 may transmit one data stream to the base station 220 via one of the plurality of antennas 340 in case that the hearing aid compatibility mode is activated, even if the number of data streams configured by the base station 220 is at least two or more. A mode in which one data stream is transmitted to the base station 220 via at least one of the plurality of antennas 340 may be defined as a second mode. Upon receiving information indicating that the hearing aid compatibility mode is activated in the electronic device 101, the electronic device 101 and the base station 220 may preconfigure a rule instructing the electronic device 101 to transmit one data stream to the base station 220, even if the number of data streams configured by the base station 220 is at least two or more.

The processor 320 may transmit information indicating that the hearing aid compatibility mode is activated in the electronic device 101 to the base station 220, and then transmit call-related packets to the base station 220 via at least one of the plurality of antennas 340.

According to an example, a call-related packet may be implemented as one data layer and then transmitted to the base station 220. The processor 320 may transmit call-related packets via two or more antennas. However, respective signals output via two or more antennas may be configured to include the same data.

Upon receiving, from the electronic device 101, information indicating that a hearing aid compatibility mode is activated in the electronic device 101, the base station 220 may activate the voice priority mode. The activation of the voice priority mode by the base station 220 may refer to a configuration for preferentially transmitting call-related packets, as compared to other packets. The base station 220 may preferentially transmit call-related packets to the electronic device 101, and transmit other packets to the electronic device 101 after the call-related packets are transmitted. In connection with transmitting call-related packets, the base station 220 may configure the number of layers of the data stream to be reduced. According to an example, upon receiving information indicating that the hearing aid compatibility mode is activated in the electronic device 101 from the electronic device 101, the base station 220 may reduce the number of layers of the data stream to one (or switch to the second mode).

In case that the hearing aid compatibility mode is activated in the electronic device 101, and in case that the base station 220 does not support the voice priority mode in which call-related packets are transmitted and/or received with higher priority than other packets, the processor 320 may perform an operation of inducing the base station 220 to control the electronic device 101 to switch from the first mode to the second mode.

For example, a situation in which the base station 220 controls the electronic device 101 to switch from the first mode to the second mode may occur in case that the quality of a channel established between the electronic device 101 and the base station 220 is low. Therefore, the processor 320 may control the communication circuitry 330 to transmit information indicating a quality lower (or worse) than the actual quality of the channel established (or provided/generated) between the electronic device 101 and the base station 220 to the base station 220. According to an example, the processor 320 may transmit a channel state information report (CSI report) including information indicating a quality lower (or worse) than the actual quality of the channel established (or provided/generated) between the electronic device 101 and the base station 220 to the base station 220. Based on the channel state information report transmitted by the electronic device 101, the base station 220 may identify that the quality between the electronic device 101 and the base station 220 is deteriorated (or poor), and may transmit, to the electronic device 101, a signal (for example, RRC reconfiguration message) instructing the electronic device 101 to switch from the first mode to the second mode. Upon receiving the signal instructing a transition from the first mode to the second mode from the base station 220, the processor 320 may switch from the first mode to the second mode, and may transmit one data layer including call-related packets to the base station 220.

For example, a situation in which the base station 220 controls the electronic device 101 to switch from the first mode to the second mode may occur in case that the channel established between the electronic device 101 and the base station 220 has a low quality. Therefore, the processor 320 may control the communication circuitry 330 to transmit a rank indicator to the base station 220 such that the value of the maximum rank supported by the electronic device 101 is configured lower than the actual value. According to an example, the processor 320 may transmit a channel state information report (CSI report) including a rank indicator that configures the value of the maximum rank supported by the electronic device 101 to be lower than the actual value to the base station 220. Based on the channel state information report transmitted by the electronic device 101, the base station 220 may identify that the quality between the electronic device 101 and the base station 220 is deteriorated (or poor), and transmit a signal (e.g., an RRC reconfiguration message) for instructing the electronic device 101 to switch from the first mode to the second mode to the electronic device 101. Upon receiving the signal instructing a transition from the first mode to the second mode from the base station 220, the processor 320 may switch from the first mode to the second mode, and may transmit one data layer including call-related packets to the base station 220.

The above-described example relates to an operation based on whether or not the base station 220 supports the voice priority mode. However, the electronic device 101 according to the disclosure may also operate in consideration of whether the base station 220 supports configuration of cellular wireless communication based on UE assistance information. The electronic device 101 may receive an RRC reconfiguration message from the base station 220 and then transmit, to the base station 220, UE assistance information including configuration (e.g., the maximum number of layers used for UL-MIMO or DL-MIMO) of cellular wireless communication supportable by the electronic device 101. The base station 220 may configure cellular wireless communication in consideration of configuration of the cellular wireless communication supportable by the electronic device 101 included in the UE assistance information. For example, the base station 220 supporting configuration of cellular wireless communication based on UE assistance information may configure the same number of data layers as the maximum number of layers that may be used for UL-MIMO or DL-MIMO included in the UE assistance information, and may transmit an RRC reconfiguration message including information indicating the number of configured data layers to the electronic device 101.

The processor 320 may identify whether the base station 220 supports configuration of cellular wireless communication based on UE assistance information. According to an example, the processor 320 may receive an RRC reconfiguration message from the base station 220 during a process of initially accessing the base station 220 (e.g., a process in which the electronic device 101 hands over from another base station to the base station 220) or a process of switching the RRC state (e.g., switching from an RRC idle state to an RRC connected state). The RRC reconfiguration message received from the base station 220 may include information indicating whether the base station 220 supports configuration of cellular wireless communication based on UE assistance information.

In case that the hearing aid compatibility mode is activated in the electronic device 101, and in case that the base station 220 supports configuration of cellular wireless communication based on UE assistance information, the processor 320 may transmit UE assistance information to the base station 220 so as to switch from the first mode to the second mode. As described above, the first mode may refer to a mode (e.g., SMDL) in which signals including different parts of data to be transmitted are transmitted via a plurality of antennas, and the second mode may refer to a mode (e.g., SMSL) in which a signal including data to be transmitted is transmitted via at least one antenna among a plurality of antennas.

The UE assistance information for switching from the first mode to the second mode may be included in a field indicating the maximum number of layers of MIMO among fields included in the UE assistance information (e.g., maximum number of MIMO layers). According to an example, the processor 320 may transmit UE assistance information in which the maximum number of MIMO layers is set to 1 to the base station 220, thereby inducing the base station 220 to control the electronic device 101 to switch from the first mode to the second mode.

In order to transmit call-related packets to the base station 220 via at least one of the plurality of antennas 340, the processor 320 may reduce the number of layers of data streams transmitted to the base station 220. Reducing the number of layers of data streams transmitted to the base station 220 may indicate that the number of antennas used by the electronic device 101 to transmit signals to the base station 220 may be reduced. Reducing the number of antennas used to transmit signals may reduce the magnitude of a magnetic field generated by a change in the signal output. The reduced magnitude of the magnetic field may reduce the interference experienced by the wearable device due to signals output by the electronic device 101.

According to an example, in a situation in which the electronic device 101 performs UL-MIMO via a TDD channel, reducing the number of layers of data streams may reduce the change in strength of signals that are output, thereby reducing the magnitude of the magnetic field.

In line with switching to the second mode, the processor 320 may control the communication circuitry 330 to output a signal including call-related packets via at least one of the plurality of antennas 340.

According to an example, call-related packets may be implemented as one data layer and transmitted to the base station 220. The processor 320 may transmit call-related packets via two or more antennas. However, respective signals output via two or more antennas may be configured to include the same data.

In case that the hearing aid compatibility mode is activated in the electronic device 101, and in case that the base station 220 does not support configuration of cellular wireless communication based on UE assistance information, the processor 320 may perform an operation of inducing the base station 220 to control the electronic device 101 to switch from the first mode to the second mode.

For example, a situation in which the base station 220 controls the electronic device 101 to switch from the first mode to the second mode may occur in case that the quality of a channel established between the electronic device 101 and the base station 220 is low. Therefore, the processor 320 may control the communication circuitry 330 to transmit information indicating a quality lower (or worse) than the actual quality of the channel established (or provided/generated) between the electronic device 101 and the base station 220 to the base station 220. According to an example, the processor 320 may transmit a channel state information report (CSI report) including information indicating a quality lower (or worse) than the actual quality of the channel established (or provided/generated) between the electronic device 101 and the base station 220 to the base station 220. Based on the channel state information report transmitted by the electronic device 101, the base station 220 may identify that the quality between the electronic device 101 and the base station 220 is deteriorated (or poor), and may transmit, to the electronic device 101, a signal (for example, RRC reconfiguration message) instructing the electronic device 101 to switch from the first mode to the second mode. Upon receiving the signal instructing a transition from the first mode to the second mode from the base station 220, the processor 320 may switch from the first mode to the second mode, and may transmit one data layer including call-related packets to the base station 220.

For example, a situation in which the base station 220 controls the electronic device 101 to switch from the first mode to the second mode may occur in case that the channel established between the electronic device 101 and the base station 220 has a low quality. Therefore, the processor 320 may control the communication circuitry 330 to transmit a rank indicator to the base station 220 such that the value of the maximum rank supported by the electronic device 101 is configured lower than the actual value. According to an example, the processor 320 may transmit a channel state information report (CSI report) including a rank indicator that configures the value of the maximum rank supported by the electronic device 101 to be lower than the actual value to the base station 220. Based on the channel state information report transmitted by the electronic device 101, the base station 220 may identify that the quality between the electronic device 101 and the base station 220 is deteriorated (or poor), and transmit a signal (e.g., an RRC reconfiguration message) for instructing the electronic device 101 to switch from the first mode to the second mode to the electronic device 101. Upon receiving the signal instructing a transition from the first mode to the second mode from the base station 220, the processor 320 may switch from the first mode to the second mode, and may transmit one data layer including call-related packets to the base station 220.

The above-described example relates to an operation based on whether or not the base station 220 supports configuration of cellular wireless communication based on UE assistance information. However, the electronic device 101 according to the disclosure may also operate in consideration of both whether the base station 220 supports the voice priority mode and whether the base station 220 supports configuration of cellular wireless communication based on UE assistance information.

Upon identifying that the hearing aid compatibility mode is activated in the electronic device 101, the processor 320 may perform an operation for reducing the magnitude of the magnetic field generated by signal output via a plurality of antennas (or, for reducing (or preventing) interference of the wearable device (e.g., a hearing aid)).

The processor 320 may identify whether the base station 220 supports a voice priority mode in which call-related packets are transmitted with higher priority than other packets. According to an example, the processor 320 may receive an RRC reconfiguration message from the base station 220 during a process of initially accessing the base station 220 (e.g., a process in which the electronic device 101 hands over from another base station to the base station 220) or a process of switching the RRC state (e.g., switching from an RRC idle state to an RRC connected state). The RRC reconfiguration message received from the base station 220 may include information indicating whether the base station 220 supports the voice priority mode. The voice priority mode may refer to a mode in which the base station 220 or the electronic device 101 preferentially processes transmission and/or reception of call-related packets, as compared to transmission and/or reception of other types of packets (e.g., packets including user data). The base station 220 supporting the voice priority mode may reduce the delay time of transmission and/or reception of call-related packets as compared to base stations not supporting the voice priority mode.

The processor 320 may identify whether the base station 220 supports the voice priority mode, based on information indicating whether the base station 220 supports the voice priority mode, included in the RRC reconfiguration message received from the base station 220.

In case that the hearing aid compatibility mode is activated in the electronic device 101, and in case that the base station 220 supports the voice priority mode in which call-related packets are transmitted and/or received with higher priority than other packets, the processor 320 may control the communication circuitry 330 to transmit call-related packets to the base station 220 via at least of the plurality of antennas 340.

In order to transmit call-related packets to the base station 220 via at least one of the plurality of antennas 340, the processor 320 may reduce the number of layers of data streams transmitted to the base station 220. The reduced number of layers of data streams transmitted to the base station 220 may refer to a possible reduction in the number of antennas used by the electronic device 101 to transmit signals to the base station 220. Reducing the number of antennas used to transmit signals may reduce the magnitude of a magnetic field generated by a change in signal output. The reduced magnitude of the magnetic field may reduce the interference experienced by the wearable device due to signals output by the electronic device 101.

According to an example, in a situation in which the electronic device 101 performs UL-MIMO via a TDD channel, reducing the number of layers of data streams may reduce the change in strength of signals that are output, thereby reducing the magnitude of the magnetic field.

The processor 320 may transmit information indicating that the hearing aid compatibility mode is activated in the electronic device 101 to the base station 220, and then transmit call-related packets to the base station 220 via at least one of the plurality of antennas 340.

In case that the hearing aid compatibility mode is activated in the electronic device 101, and in case that the base station 220 does not support the voice priority mode in which call-related packets are transmitted and/or received with higher priority than other packets, the processor 320 may identify whether the base station 220 supports configuration of cellular wireless communication based on UE assistance information. According to an example, the processor 320 may receive an RRC reconfiguration message from the base station 220 in a process of initially accessing the base station 220 (e.g., a process in which the electronic device 101 hands over from another base station to the base station 220) or in a process of switching the RRC state (e.g., switching from an RRC idle state to an RRC connected state). The RRC reconfiguration message received from the base station 220 may include information indicating whether the base station 220 supports configuration of cellular wireless communication based on UE assistance information.

In case that the hearing aid compatibility mode is activated in the electronic device 101, and in case that the base station 220 supports configuration of cellular wireless communication based on UE assistance information, the processor 320 may transmit UE assistance information to the base station 220 so as to switch from the first mode to the second mode. As described above, the first mode may refer to a mode (e.g., SMDL) in which signals including different parts of data to be transmitted are transmitted via a plurality of antennas, and the second mode may refer to a mode (e.g., SMSL) in which a signal including data to be transmitted is transmitted via at least one antenna among a plurality of antennas.

The UE assistance information for switching from the first mode to the second mode may be included in a field indicating the maximum number of layers of MIMO among fields included in the UE assistance information (e.g., maximum number of MIMO layers). According to an example, the processor 320 may transmit UE assistance information in which the maximum number of MIMO layers is set to 1 to the base station 220, thereby inducing the base station 220 to control the electronic device 101 to switch from the first mode to the second mode.

In order to transmit call-related packets to the base station 220 via at least one of the plurality of antennas 340, the processor 320 may reduce the number of layers of data streams transmitted to the base station 220. Reducing the number of layers of data streams transmitted to the base station 220 may indicate that the number of antennas used by the electronic device 101 to transmit signals to the base station 220 may be reduced. Reducing the number of antennas used to transmit signals may reduce the magnitude of a magnetic field generated by a change in the signal output. The reduced magnitude of the magnetic field may reduce the interference experienced by the wearable device due to signals output by the electronic device 101.

In case that the hearing aid compatibility mode is activated in the electronic device 101, and in case that the base station 220 does not support configuration of cellular wireless communication based on UE assistance information, the processor 320 may perform an operation of inducing the base station 220 to control the electronic device 101 to switch from the first mode to the second mode.

For example, a situation in which the base station 220 controls the electronic device 101 to switch from the first mode to the second mode may occur in case that the quality of a channel established between the electronic device 101 and the base station 220 is low. Therefore, the processor 320 may control the communication circuitry 330 to transmit information indicating a quality lower (or worse) than the actual quality of the channel established (or provided/generated) between the electronic device 101 and the base station 220 to the base station 220. According to an example, the processor 320 may transmit a channel state information report (CSI report) including information indicating a quality lower (or worse) than the actual quality of the channel established (or provided/generated) between the electronic device 101 and the base station 220 to the base station 220. Based on the channel state information report transmitted by the electronic device 101, the base station 220 may identify that the quality between the electronic device 101 and the base station 220 is deteriorated (or poor), and may transmit, to the electronic device 101, a signal (for example, RRC reconfiguration message) instructing the electronic device 101 to switch from the first mode to the second mode. Upon receiving the signal instructing a transition from the first mode to the second mode from the base station 220, the processor 320 may switch from the first mode to the second mode, and may transmit one data layer including call-related packets to the base station 220.

For example, a situation in which the base station 220 controls the electronic device 101 to switch from the first mode to the second mode may occur in case that the channel established between the electronic device 101 and the base station 220 has a low quality. Therefore, the processor 320 may control the communication circuitry 330 to transmit a rank indicator to the base station 220 such that the value of the maximum rank supported by the electronic device 101 is configured lower than the actual value. According to an example, the processor 320 may transmit a channel state information report (CSI report) including a rank indicator that configures the value of the maximum rank supported by the electronic device 101 to be lower than the actual value to the base station 220. Based on the channel state information report transmitted by the electronic device 101, the base station 220 may identify that the quality between the electronic device 101 and the base station 220 is deteriorated (or poor), and transmit a signal (e.g., an RRC reconfiguration message) for instructing the electronic device 101 to switch from the first mode to the second mode to the electronic device 101. Upon receiving the signal instructing a transition from the first mode to the second mode from the base station 220, the processor 320 may switch from the first mode to the second mode, and may transmit one data layer including call-related packets to the base station 220.

The electronic device 101 may switch from the first mode to the second mode in case that the hearing aid compatibility mode is activated, according to the above-described scheme, thereby reducing (or minimizing) the interference applied to the wearable device (or the hearing aid).

According to an example, the processor 320 may transmit data to the base station 220 via at least one of the plurality of antennas 340 in response to switching from the first mode to the second mode. By configuring at least some of the antennas, which have been outputting signals in the first mode, not to output signals, the interference applied to the wearable device (or the hearing aid) may be reduced (or minimized). Signals transmitted by the electronic device 101 in the second mode may be transmitted to the base station 220 via a time division duplex channel.

The processor 320 may activate uplink carrier aggregation in accordance with the state of the electronic device 101 satisfying a first condition. The uplink carrier aggregation may refer to a case in which the electronic device 101 transmits signals to the base station 220 via at least two channels. According to an example, the processor 320 may transmit signals to the base station 220 via a frequency division duplex (FDD) channel and a TDD channel, based on the state of the electronic device 101 satisfying the first condition.

According to an example, the first condition may refer to a condition that the required throughput of a service performed together while the electronic device 101 performs a phone service is equal to or larger (or exceeds) a specified size. For example, the first condition may include a condition that the required throughput of a specific application currently running on the electronic device 101 is equal to or larger (or exceeds) a specified size.

In order to perform uplink carrier aggregation using a frequency division duplex channel and a time division duplex channel, the processor 320 may transmit a signal (e.g., downlink control information (DCI)) for requesting timing information for switching from signal transmission via a frequency division duplex channel to signal transmission via a time division duplex channel (or timing information for switching from signal transmission via a time division duplex channel to signal transmission via a frequency division duplex channel) to the base station 220. The base station 220 may transmit a signal (e.g., DCI) including timing information for switching from signal transmission via a frequency division duplex channel to signal transmission via a time division duplex channel (or timing information for switching from signal transmission via a time division duplex channel to signal transmission via a frequency division duplex channel) to the electronic device 101.

The processor 320 may transmit signals including call-related packets to the base station 220 via a frequency division duplex channel, and may transmit other packets (e.g., packets including user data) to the base station 220 via a time division duplex channel during a specific period, based on timing information received from the base station 220. Alternatively, the processor 320 may transmit signals including call-related packets to the base station 220 via a time division duplex channel, and may transmit other packets (e.g., packets including user data) to the base station 220 via a frequency division duplex channel during a specific period, based on timing information received from the base station 220.

The processor 320 may transmit signals to the base station 220 via a frequency division duplex channel rather than a time division duplex channel activated in the first mode in accordance with the state of the electronic device 101 satisfying the second condition.

According to an example, the second condition may refer to a condition indicating that the interference applied to the wearable device (or the hearing aid) is substantial. Alternatively, the second condition may include a condition in which the quality of the channel between the electronic device 101 and the base station 220 is relatively good.

According to an example, the processor 320 may perform an operation of inducing a transition from a time division duplex channel to a frequency division duplex channel, based on the state of the electronic device 101 satisfying the second condition. For example, the processor 320 may switch to the frequency division duplex channel by transmitting, to the base station 220, a measurement report in which the quality of the time division duplex channel is configured to be lower than the actual quality.

The processor 320 may switch from the second mode to the first mode in accordance with completion (or termination) of the call service. According to an example, the processor 320 may transmit, to the base station 220, a channel state information report including the actual quality of the channel established between the electronic device 101 and the base station 220, thereby inducing the base station 220 such that the electronic device 101 switches from the second mode to the first mode. According to an example, the processor 320 may transmit a channel state information report (CSI report) including a rank indicator configured to have the same value as the maximum rank supported by the electronic device 101 to the base station 220, thereby inducing the base station 220 such that the electronic device 101 switches from the second mode to the first mode. The processor 320 may configure the number of layers of data streams to be identical to the number of layers of data streams before performing the call service. For example, in case that the processor 320 has operated in a mode (e.g., SMDL) of transmitting two data layers to the base station 220 before performing the call service, the processor 320 may transmit two data layers to the base station 220 as the call service is completed (or terminated).

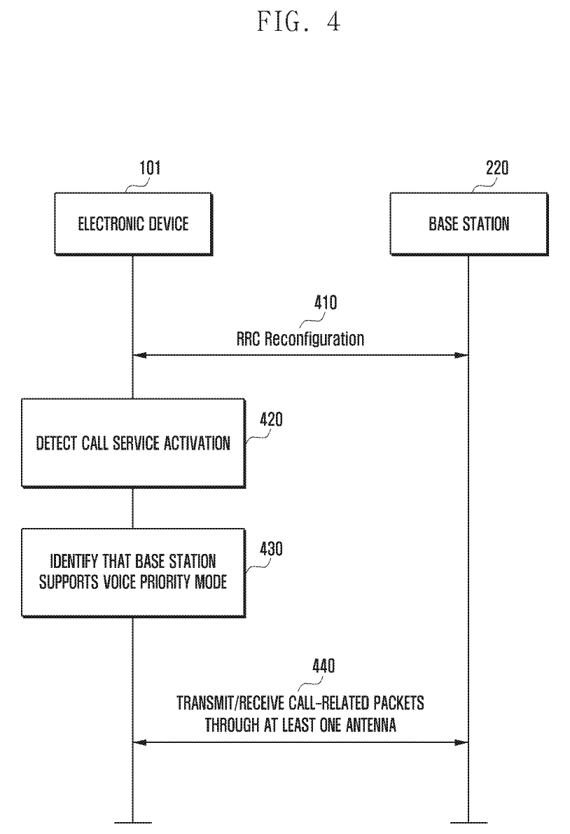

FIG. 4 is a diagram illustrating an example in which an electronic device transmits call-related packets via at least one of a plurality of antennas, in case that a base station supports a voice priority mode according to an embodiment of the disclosure.

The electronic device (e.g., the electronic device 101 in FIG. 3) and the base station (e.g., the base station 220 in FIG. 2A) may perform RRC reconfiguration in operation 410.

The electronic device 101 may receive an RRC reconfiguration message from the base station 220 and perform cellular communication using a plurality of antennas 340, based on information related to a signal transmission scheme using a plurality of antennas 340 included in the RRC reconfiguration message.

According to an example, in case that the base station 220 (or the cellular network) supports uplink multiple-input multiple-output (UL-MIMO), the electronic device 101 may receive an RRC reconfiguration message including a configuration related to the UL-MIMO. According to an example, the configuration related to UL-MIMO may include at least one of whether the UL-MIMO is activated, the number of antennas that may be used by the electronic device 101 to transmit signals to the base station 220, or the number of layers (Tx layers) of data to be transmitted by the electronic device 101 to the base station 220.

The electronic device 101 may receive an RRC reconfiguration message including a configuration related to UL-MIMO from the base station 220, and transmit signals via a plurality of antennas 340, based on the configuration related to UL-MIMO. In case that the electronic device 101 performs UL-MIMO, data included in a signal output via one of the plurality of antennas 340 and data included in a signal output via another of the plurality of antennas 340 may differ from each other. The electronic device 101 may improve the data transmission rate (or throughput) by transmitting respective signals including different parts of data to be transmitted to the base station 220 via the plurality of antennas 340.

The electronic device 101 performing UL-MIMO may support various modes according to the number of layers of data transmitted by the electronic device 101. According to an example, the number of layers may refer to the number of individual data streams transmitted in case that the electronic device 101 transmits a plurality of data streams via a plurality of antennas 340. According to an example, the description that the number of layers of data is two may mean that two data streams including different pieces of data may be transmitted via the plurality of antennas 340. A mode for transmitting at least two or more data layers may be defined as a first mode. A mode for transmitting two data layers may be referred to as a spatially multiplexed dual layer (SMDL). A mode for transmitting one data layer may be referred to as a second mode (or spatially multiplexed single layer (SMSL)).

According to an example, the electronic device 101 may perform cellular wireless communication in a first mode (e.g., SMDL) that supports transmission of at least two or more data layers. The electronic device 101 may control the communication circuitry 330 to transmit signals including different pieces of data obtained by dividing data to be transmitted, according to the configured number of layers, to the base station 220 via the plurality of antennas 340.

The electronic device 101 may detect activation of a call service in operation 420.

The electronic device 101 may detect activation of a call service while performing cellular wireless communication in a first mode (e.g., SMDL) supporting transmission of at least two or more data layers.

According to an example, the electronic device 101 may detect activation of a call service according to execution of an application related to the call service. According to another example, the electronic device 101 may detect activation of a call service in response to receiving a signal (e.g., a paging message) indicating activation of a call service from the base station 220

The electronic device 101 may identify whether a wearable device (e.g., a hearing aid) is adjacent to the electronic device 101 in response to detecting activation of a call service. Alternatively, the electronic device 101 may identify whether the wearable device (e.g., a hearing aid) is likely to be adjacent to the electronic device 101, in response to detecting activation of the call service. The wearable device may refer to various electronic devices that may possibly experience interference in operations of the wearable device by signals output by the electronic device 101 while the electronic device 101 performs a call service. Although a hearing aid is given as a representative example of the wearable device in the disclosure, the wearable device is not limited to a hearing aid, and may refer to various electronic devices that may possibly experience interference by signals output by the electronic device 101 while the electronic device 101 performs a call service.

For example, the electronic device 101 may identify whether a hearing aid compatibility mode is activated in the electronic device 101. Activation of the hearing aid compatibility mode in the electronic device 101 may indicate that the user of the electronic device 101 is wearing a hearing aid, and that the hearing aid is likely to be affected by signals output while a call service is performed using the electronic device 101.

In response to identifying that a hearing aid compatibility mode is activated in the electronic device 101, the electronic device 101 may perform an operation for reducing the magnitude of a magnetic field generated by output of signals via the plurality of antennas (or for reducing (or preventing) interference of a wearable device (e.g., a hearing aid)).

The electronic device 101 may identify that the base station 220 supports the voice priority mode, in operation 430.

The electronic device 101 may identify whether the base station 220 supports a voice priority mode in which call-related packets are transmitted with higher priority than other packets. According to an example, the electronic device 101 may receive an RRC reconfiguration message from the base station 220 during a process of initially accessing the base station 220 (e.g., a process in which the electronic device 101 hands over from another base station to the base station 220) or a process of switching the RRC state (e.g., switching from an RRC idle state to an RRC connected state). The RRC reconfiguration message received from the base station 220 may include information indicating whether the base station 220 supports the voice priority mode. The RRC reconfiguration message may be identical to the RRC reconfiguration message that the electronic device 101 receives from the base station 220 in operation 410. The voice priority mode may refer to a mode in which the base station 220 or the electronic device 101 preferentially processes transmission and/or reception of call-related packets, as compared to transmission and/or reception of other types of packets (e.g., packets including user data). The base station 220 supporting the voice priority mode may reduce the delay time of transmission and/or reception of call-related packets as compared to base stations not supporting the voice priority mode. The electronic device 101 may also identify whether the voice priority mode is supported based on an RRC reconfiguration message different from the RRC reconfiguration message received in operation 410.

In case that the base station 220 supporting the voice priority mode receives a specific signal (e.g., information indicating that the hearing aid compatibility mode is activated) from the electronic device 101, the base station 220 may transmit one data layer to the electronic device 101, when transmitting call-related packets, even if the electronic device 101 is configured to operate in a mode of transmitting a plurality of data layers.

The electronic device 101 may identify whether the base station 220 supports the voice priority mode, based on the information indicating whether the voice priority mode is supported, which is included in the RRC reconfiguration message received from the base station 220.

The electronic device 101 may transmit/receive call-related packets via at least one antenna in operation 440.

In case that the hearing aid compatibility mode is activated in the electronic device 101, and in case that the base station 220 supports the voice priority mode in which call-related packets are transmitted and/or received with higher priority than other packets, the electronic device 101 may control the communication circuitry 330 to transmit call-related packets to the base station 220 via at least one of the plurality of antennas 340.

In order to transmit call-related packets to the base station 220 via at least one of the plurality of antennas 340, the electronic device 101 may reduce the number of layers of data streams transmitted to the base station 220. The reduced number of layers of data streams transmitted to the base station 220 may refer to a possible reduction in the number of antennas used by the electronic device 101 to transmit signals to the base station 220. Reducing the number of antennas used to transmit signals may reduce the magnitude of a magnetic field generated by a change in signal output. The reduced magnitude of the magnetic field may reduce the interference experienced by the wearable device due to signals output by the electronic device 101.

According to an example, in a situation in which the electronic device 101 performs UL-MIMO via a TDD channel, reducing the number of layers of data streams may reduce the change in strength of signals that are output, thereby reducing the magnitude of the magnetic field.

The electronic device 101 may transmit one data stream to the base station 220 via one of the plurality of antennas 340 in case that the hearing aid compatibility mode is activated, even if the number of data streams configured by the base station 220 is at least two or more. A mode in which one data stream is transmitted to the base station 220 via at least one of the plurality of antennas 340 may be defined as a second mode. Upon receiving information indicating that the hearing aid compatibility mode is activated in the electronic device 101, the electronic device 101 and the base station 220 may preconfigure a rule instructing the electronic device 101 to transmit one data stream to the base station 220, even if the number of data streams configured by the base station 220 is at least two or more.

The electronic device 101 may transmit information indicating that the hearing aid compatibility mode is activated in the electronic device 101 to the base station 220, and then transmit call-related packets to the base station 220 via at least one of the plurality of antennas 340.

According to an example, a call-related packet may be implemented as one data layer and then transmitted to the base station 220. The electronic device 101 may transmit call-related packets via two or more antennas. However, respective signals output via two or more antennas may be configured to include the same data.

Upon receiving, from the electronic device 101, information indicating that a hearing aid compatibility mode is activated in the electronic device 101, the base station 220 may activate the voice priority mode. The activation of the voice priority mode by the base station 220 may refer to a configuration for preferentially transmitting call-related packets, as compared to other packets. The base station 220 may preferentially transmit call-related packets to the electronic device 101, and transmit other packets to the electronic device 101 after the call-related packets are transmitted. In connection with transmitting call-related packets, the base station 220 may configure the number of layers of the data stream to be reduced. According to an example, upon receiving information indicating that the hearing aid compatibility mode is activated in the electronic device 101 from the electronic device 101, the base station 220 may reduce the number of layers of the data stream to one (or switch to the second mode).

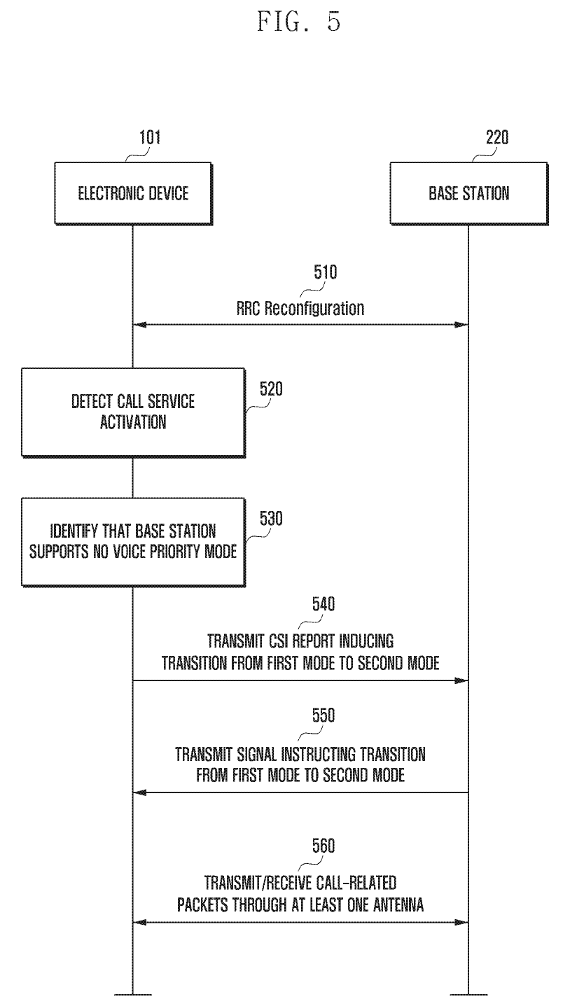

FIG. 5 illustrates an example in which an electronic device transmits call-related packets via at least one of a plurality of antennas, in case that a base station does not support a voice priority mode according to an embodiment of the disclosure.

The electronic device (e.g., the electronic device 101 in FIG. 3) and the base station (e.g., the base station 220 in FIG. 2A) may perform RRC reconfiguration in operation 510.

The electronic device 101 may receive an RRC reconfiguration message from the base station 220 and perform cellular communication using a plurality of antennas 340, based on information related to a signal transmission scheme using a plurality of antennas 340 included in the RRC reconfiguration message.

According to an example, in case that the base station 220 (or the cellular network) supports uplink multiple-input multiple-output (UL-MIMO), the electronic device 101 may receive an RRC reconfiguration message including a configuration related to the UL-MIMO. According to an example, the configuration related to UL-MIMO may include at least one of whether the UL-MIMO is activated, the number of antennas that may be used by the electronic device 101 to transmit signals to the base station 220, or the number of layers (Tx layers) of data to be transmitted by the electronic device 101 to the base station 220.

The electronic device 101 may receive an RRC reconfiguration message including a configuration related to UL-MIMO from the base station 220, and transmit signals via a plurality of antennas 340, based on the configuration related to UL-MIMO. In case that the electronic device 101 performs UL-MIMO, data included in a signal output via one of the plurality of antennas 340 and data included in a signal output via another of the plurality of antennas 340 may differ from each other. The electronic device 101 may improve the data transmission rate (or throughput) by transmitting respective signals including different parts of data to be transmitted to the base station 220 via the plurality of antennas 340.

The electronic device 101 performing UL-MIMO may support various modes according to the number of layers of data transmitted by the electronic device 101. According to an example, the number of layers may refer to the number of individual data streams transmitted in case that the electronic device 101 transmits a plurality of data streams via a plurality of antennas 340. According to an example, the description that the number of layers of data is two may mean that two data streams including different pieces of data may be transmitted via the plurality of antennas 340. A mode for transmitting at least two or more data layers may be defined as a first mode. A mode for transmitting two data layers may be referred to as a spatially multiplexed dual layer (SMDL). A mode for transmitting one data layer may be referred to as a second mode (or spatially multiplexed single layer (SMSL)).

According to an example, the electronic device 101 may perform cellular wireless communication in a first mode (e.g., SMDL) that supports transmission of at least two or more data layers. The electronic device 101 may control the communication circuitry 330 to transmit signals including different pieces of data obtained by dividing data to be transmitted, according to the configured number of layers, to the base station 220 via the plurality of antennas 340.

The electronic device 101 may detect activation of a call service in operation 520.

The electronic device 101 may detect activation of a call service while performing cellular wireless communication in a first mode (e.g., SMDL) supporting transmission of at least two or more data layers.

According to an example, the electronic device 101 may detect activation of a call service according to execution of an application related to the call service. According to another example, the electronic device 101 may detect activation of a call service in response to receiving a signal (e.g., a paging message) indicating activation of a call service from the base station 220.

The electronic device 101 may identify whether a wearable device (e.g., a hearing aid) is adjacent to the electronic device 101 in response to detecting activation of a call service. Alternatively, the electronic device 101 may identify whether the wearable device (e.g., a hearing aid) is likely to be adjacent to the electronic device 101, in response to detecting activation of the call service. The wearable device may refer to various electronic devices that may possibly experience interference in operations of the wearable device by signals output by the electronic device 101 while the electronic device 101 performs a call service. Although a hearing aid is given as a representative example of the wearable device in the disclosure, the wearable device is not limited to a hearing aid, and may refer to various electronic devices that may possibly experience interference by signals output by the electronic device 101 while the electronic device 101 performs a call service.

For example, the electronic device 101 may identify whether a hearing aid compatibility mode is activated in the electronic device 101. Activation of the hearing aid compatibility mode in the electronic device 101 may indicate that the user of the electronic device 101 is wearing a hearing aid, and that the hearing aid is likely to be affected by signals output while a call service is performed using the electronic device 101.

In response to identifying that a hearing aid compatibility mode is activated in the electronic device 101, the electronic device 101 may perform an operation for reducing the magnitude of a magnetic field generated by output of signals via the plurality of antennas (or for reducing (or preventing) interference of a wearable device (e.g., a hearing aid)).

The electronic device 101 may identify that the base station 220 supports no voice priority mode, in operation 530.

The electronic device 101 may identify whether the base station 220 supports a voice priority mode in which call-related packets are transmitted with higher priority than other packets. According to an example, the electronic device 101 may receive an RRC reconfiguration message from the base station 220 during a process of initially accessing the base station 220 (e.g., a process in which the electronic device 101 hands over from another base station to the base station 220) or a process of switching the RRC state (e.g., switching from an RRC idle state to an RRC connected state). The RRC reconfiguration message received from the base station 220 may include information indicating whether the base station 220 supports the voice priority mode. The voice priority mode may refer to a mode in which the base station 220 or the electronic device 101 preferentially processes transmission and/or reception of call-related packets, as compared to transmission and/or reception of other types of packets (e.g., packets including user data).

The electronic device 101 may perform an operation of inducing the base station 220 to control the electronic device 101 to switch from the first mode to the second mode, in case that the hearing aid compatibility mode is activated in the electronic device 101, and in case that the base station 220 supports no voice priority mode in which call-related packets are transmitted and/or received with higher priority than other packets.

The electronic device 101 may transmit a channel state information report for inducing a transition from the first mode to the second mode to the base station 220 in operation 540.

The electronic device 101 may perform an operation of inducing the base station 220 to control the electronic device 101 to switch from the first mode to the second mode, in case that the hearing aid compatibility mode is activated in the electronic device 101, and in case that the base station 220 supports no voice priority mode in which call-related packets are transmitted and/or received with higher priority than other packets.

For example, a situation in which the base station 220 controls the electronic device 101 to switch from the first mode to the second mode may occur in case that the quality of a channel established between the electronic device 101 and the base station 220 is low. Therefore, the electronic device 101 may control the communication circuitry 330 to transmit information indicating a quality lower (or worse) than the actual quality of the channel established (or provided/generated) between the electronic device 101 and the base station 220 to the base station 220. According to an example, the electronic device 101 may transmit a channel state information report (CSI report) including information indicating a quality lower (or worse) than the actual quality of the channel established (or provided/generated) between the electronic device 101 and the base station 220 to the base station 220.

The base station 220 may transmit a signal instructing a transition from the first mode to the second mode to the electronic device 101, in operation 550.

Based on the channel state information report transmitted by the electronic device 101, the base station 220 may identify that the quality between the electronic device 101 and the base station 220 is deteriorated (or poor), and may transmit, to the electronic device 101, a signal (for example, RRC reconfiguration message) instructing the electronic device 101 to switch from the first mode to the second mode. Upon receiving the signal instructing a transition from the first mode to the second mode from the base station 220, the electronic device 101 may switch from the first mode to the second mode, and may transmit one data layer including call-related packets to the base station 220.

For example, a situation in which the base station 220 controls the electronic device 101 to switch from the first mode to the second mode may occur in case that the channel established between the electronic device 101 and the base station 220 has a low quality. Therefore, the electronic device 101 may control the communication circuitry 330 to transmit a rank indicator to the base station 220 such that the value of the maximum rank supported by the electronic device 101 is configured lower than the actual value. According to an example, the electronic device 101 may transmit a channel state information report (CSI report) including a rank indicator that configures the value of the maximum rank supported by the electronic device 101 to be lower than the actual value to the base station 220. Based on the channel state information report transmitted by the electronic device 101, the base station 220 may identify that the quality between the electronic device 101 and the base station 220 is deteriorated (or poor), and transmit a signal (e.g., an RRC reconfiguration message) for instructing the electronic device 101 to switch from the first mode to the second mode to the electronic device 101. Upon receiving the signal instructing a transition from the first mode to the second mode from the base station 220, the electronic device 101 may switch from the first mode to the second mode, and may transmit one data layer including call-related packets to the base station 220.

The electronic device 101 may transmit/receive call-related packets via at least one antenna in operation 560.

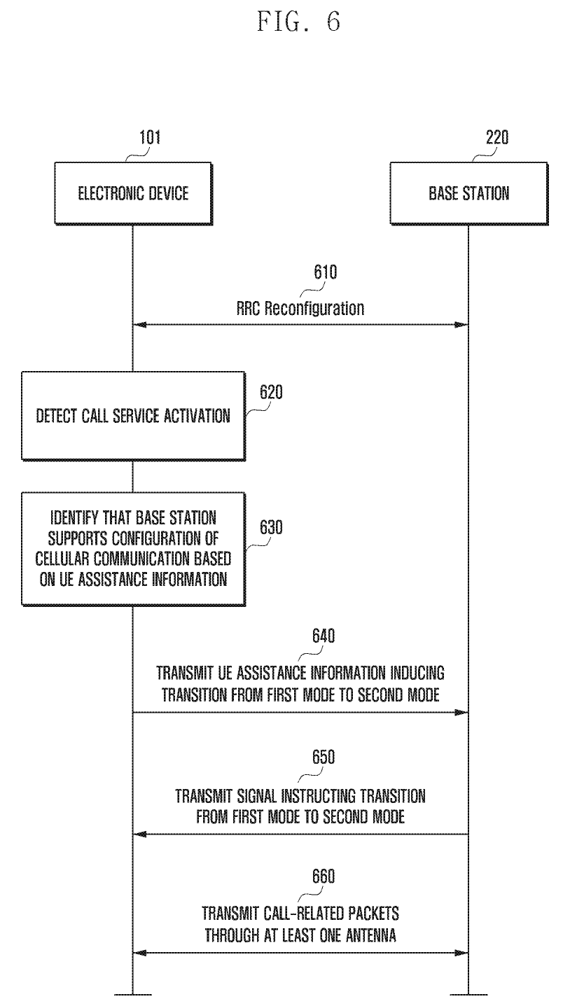

FIG. 6 illustrates an example in which an electronic device transmits call-related packets via at least one of plurality of antennas, in case that a base station supports configuration of cellular communication based on UE assistance information according to an embodiment of the disclosure.

The electronic device (e.g., the electronic device 101 in FIG. 3) and the base station (e.g., the base station 220 in FIG. 2A) may perform RRC reconfiguration in operation 610.

The electronic device 101 may receive an RRC reconfiguration message from the base station 220 and perform cellular communication using a plurality of antennas 340, based on information related to a signal transmission scheme using a plurality of antennas 340 included in the RRC reconfiguration message.

According to an example, in case that the base station 220 (or the cellular network) supports uplink multiple-input multiple-output (UL-MIMO), the electronic device 101 may receive an RRC reconfiguration message including a configuration related to the UL-MIMO. According to an example, the configuration related to UL-MIMO may include at least one of whether the UL-MIMO is activated, the number of antennas that may be used by the electronic device 101 to transmit signals to the base station 220, or the number of layers (Tx layers) of data to be transmitted by the electronic device 101 to the base station 220.

The electronic device 101 may receive an RRC reconfiguration message including a configuration related to UL-MIMO from the base station 220, and transmit signals via a plurality of antennas 340, based on the configuration related to UL-MIMO. In case that the electronic device 101 performs UL-MIMO, data included in a signal output via one of the plurality of antennas 340 and data included in a signal output via another of the plurality of antennas 340 may differ from each other. The electronic device 101 may improve the data transmission rate (or throughput) by transmitting respective signals including different parts of data to be transmitted to the base station 220 via the plurality of antennas 340.

The electronic device 101 performing UL-MIMO may support various modes according to the number of layers of data transmitted by the electronic device 101. According to an example, the number of layers may refer to the number of individual data streams transmitted in case that the electronic device 101 transmits a plurality of data streams via a plurality of antennas 340. According to an example, the description that the number of layers of data is two may mean that two data streams including different pieces of data may be transmitted via the plurality of antennas 340. A mode for transmitting at least two or more data layers may be defined as a first mode. A mode for transmitting two data layers may be referred to as a spatially multiplexed dual layer (SMDL). A mode for transmitting one data layer may be referred to as a second mode (or spatially multiplexed single layer (SMSL)).

According to an example, the electronic device 101 may perform cellular wireless communication in a first mode (e.g., SMDL) that supports transmission of at least two or more data layers. The electronic device 101 may control the communication circuitry 330 to transmit signals including different pieces of data obtained by dividing data to be transmitted, according to the configured number of layers, to the base station 220 via the plurality of antennas 340.

The electronic device 101 may detect activation of a call service in operation 620.

The electronic device 101 may detect activation of a call service while performing cellular wireless communication in a first mode (e.g., SMDL) supporting transmission of at least two or more data layers.

According to an example, the electronic device 101 may detect activation of a call service according to execution of an application related to the call service. According to another example, the electronic device 101 may detect activation of a call service in response to receiving a signal (e.g., a paging message) indicating activation of a call service from the base station 220.

The electronic device 101 may identify whether a wearable device (e.g., a hearing aid) is adjacent to the electronic device 101 in response to detecting activation of a call service. Alternatively, the electronic device 101 may identify whether the wearable device (e.g., a hearing aid) is likely to be adjacent to the electronic device 101, in response to detecting activation of the call service. The wearable device may refer to various electronic devices that may possibly experience interference in operations of the wearable device by signals output by the electronic device 101 while the electronic device 101 performs a call service. Although a hearing aid is given as a representative example of the wearable device in the disclosure, the wearable device is not limited to a hearing aid, and may refer to various electronic devices that may possibly experience interference by signals output by the electronic device 101 while the electronic device 101 performs a call service.

For example, the electronic device 101 may identify whether a hearing aid compatibility mode is activated in the electronic device 101. Activation of the hearing aid compatibility mode in the electronic device 101 may indicate that the user of the electronic device 101 is wearing a hearing aid, and that the hearing aid is likely to be affected by signals output while a call service is performed using the electronic device 101.

In response to identifying that a hearing aid compatibility mode is activated in the electronic device 101, the electronic device 101 may perform an operation for reducing the magnitude of a magnetic field generated by output of signals via the plurality of antennas (or for reducing (or preventing) interference of a wearable device (e.g., a hearing aid)).

The electronic device 101 may identify that the base station 220 supports configuration of cellular communication based on UE assistance information, in operation 630.

The electronic device 101 may identify whether the base station 220 supports configuration of cellular wireless communication based on UE assistance information. According to an example, the electronic device 101 may receive an RRC reconfiguration message from the base station 220 during a process of initially accessing the base station 220 (e.g., a process in which the electronic device 101 hands over from another base station to the base station 220) or a process of switching the RRC state (e.g., switching from an RRC idle state to an RRC connected state). The RRC reconfiguration message received from the base station 220 may include information indicating whether the base station 220 supports configuration of cellular wireless communication based on UE assistance information. The RRC reconfiguration message may be identical to the RRC reconfiguration message that the electronic device 101 receives from the base station 220 in operation 610.

The electronic device 101 may transmit UE assistance information that induces a transition from the first mode to the second mode to the base station 220 in operation 640.

In case that the hearing aid compatibility mode is activated in the electronic device 101, and in case that the base station 220 supports configuration of cellular wireless communication based on UE assistance information, the electronic device 101 may transmit UE assistance information to the base station 220 so as to switch from the first mode to the second mode. As described above, the first mode may refer to a mode (e.g., SMDL) in which signals including different parts of data to be transmitted are transmitted via a plurality of antennas, and the second mode may refer to a mode (e.g., SMSL) in which a signal including data to be transmitted is transmitted via at least one antenna among a plurality of antennas.

The UE assistance information for switching from the first mode to the second mode may be included in a field indicating the maximum number of layers of MIMO among fields included in the UE assistance information (e.g., maximum number of MIMO layers). According to an example, the electronic device 101 may transmit UE assistance information in which the maximum number of MIMO layers is set to 1 to the base station 220, thereby inducing the base station 220 to control the electronic device 101 to switch from the first mode to the second mode.

In order to transmit call-related packets to the base station 220 via at least one of the plurality of antennas 340, the electronic device 101 may reduce the number of layers of data streams transmitted to the base station 220. Reducing the number of layers of data streams transmitted to the base station 220 may indicate that the number of antennas used by the electronic device 101 to transmit signals to the base station 220 may be reduced. Reducing the number of antennas used to transmit signals may reduce the magnitude of a magnetic field generated by a change in the signal output. The reduced magnitude of the magnetic field may reduce the interference experienced by the wearable device due to signals output by the electronic device 101.

According to an example, in a situation in which the electronic device 101 performs UL-MIMO via a TDD channel, reducing the number of layers of data streams may reduce the change in strength of signals that are output, thereby reducing the magnitude of the magnetic field.

The base station 220 may transmit, to the electronic device 101, a signal instructing a transition from the first mode to the second mode in operation 650.

According to an example, the base station 220 may refer to a field indicating the maximum number of MIMO layers among the fields included in the UE assistance information transmitted by the electronic device 101, thereby identifying that the maximum number of MIMO layers supported by the electronic device 101 is 1, and may transmit, to the electronic device 101, a signal for instructing the electronic device 101 to switch from the first mode to the second mode.

The base station 220 may transmit a signal (e.g., RRC reconfiguration message) to the electronic device 101 to instruct the electronic device 101 to switch from the first mode to the second mode. Upon receiving the signal that instructs the electronic device 101 to switch from the first mode to the second mode from the base station 220, the electronic device 101 may switch from the first mode to the second mode and may transmit one data layer including call-related packets to the base station 220.

The electronic device 101 may transmit, in operation 660, call-related packets to the base station 220 via at least one antenna.

The electronic device 101 may control the communication circuitry 330 to output signals including call-related packets via at least one of the plurality of antennas 340, in accordance with switching to the second mode.

According to an example, the call-related packets may be implemented as one data layer and the transmitted to the base station 220. The electronic device 101 may transmit call-related packets via two or more antennas. However, respective signals output via two or more antennas may be configured to include the same data.

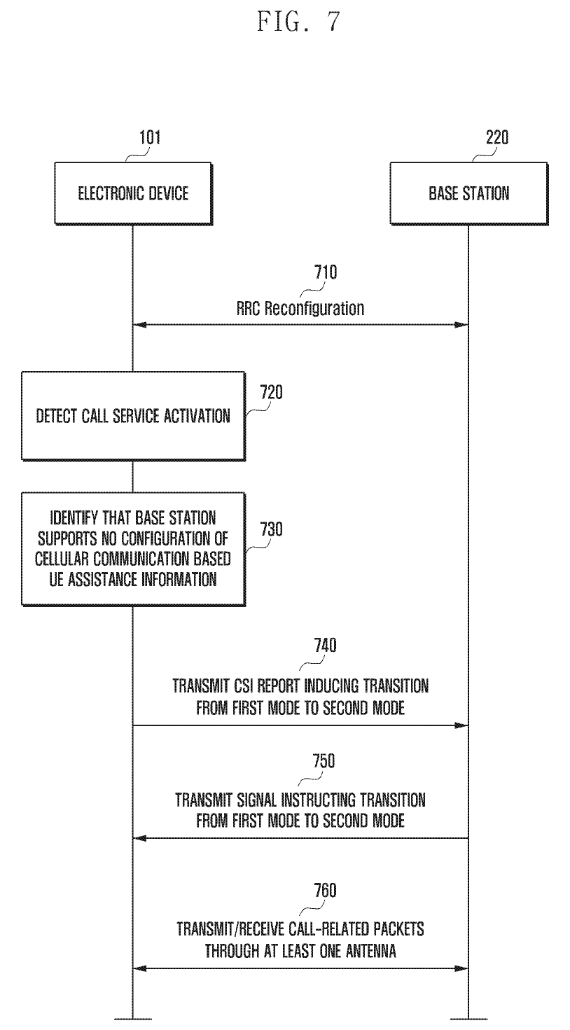

FIG. 7 illustrates an example in which an electronic device transmits call-related packets via at least one of a plurality of antennas, in case that a base station supports no configuration of cellular communication based on UE assistance information according to an embodiment of the disclosure.

The electronic device (e.g., the electronic device 101 in FIG. 3) and the base station (e.g., the base station 220 in FIG. 2A) may perform RRC reconfiguration in operation 710.

The electronic device 101 may receive an RRC reconfiguration message from the base station 220 and perform cellular communication using a plurality of antennas 340, based on information related to a signal transmission scheme using a plurality of antennas 340 included in the RRC reconfiguration message.

According to an example, in case that the base station 220 (or the cellular network) supports uplink multiple-input multiple-output (UL-MIMO), the electronic device 101 may receive an RRC reconfiguration message including a configuration related to the UL-MIMO. According to an example, the configuration related to UL-MIMO may include at least one of whether the UL-MIMO is activated, the number of antennas that may be used by the electronic device 101 to transmit signals to the base station 220, or the number of layers (Tx layers) of data to be transmitted by the electronic device 101 to the base station 220.

The electronic device 101 may receive an RRC reconfiguration message including a configuration related to UL-MIMO from the base station 220, and transmit signals via a plurality of antennas 340, based on the configuration related to UL-MIMO. In case that the electronic device 101 performs UL-MIMO, data included in a signal output via one of the plurality of antennas 340 and data included in a signal output via another of the plurality of antennas 340 may differ from each other. The electronic device 101 may improve the data transmission rate (or throughput) by transmitting respective signals including different parts of data to be transmitted to the base station 220 via the plurality of antennas 340.

The electronic device 101 performing UL-MIMO may support various modes according to the number of layers of data transmitted by the electronic device 101. According to an example, the number of layers may refer to the number of individual data streams transmitted in case that the electronic device 101 transmits a plurality of data streams via a plurality of antennas 340. According to an example, the description that the number of layers of data is two may mean that two data streams including different pieces of data may be transmitted via the plurality of antennas 340. A mode for transmitting at least two or more data layers may be defined as a first mode. A mode for transmitting two data layers may be referred to as a spatially multiplexed dual layer (SMDL). A mode for transmitting one data layer may be referred to as a second mode (or spatially multiplexed single layer (SMSL)).

According to an example, the electronic device 101 may perform cellular wireless communication in a first mode (e.g., SMDL) that supports transmission of at least two or more data layers. The electronic device 101 may control the communication circuitry 330 to transmit signals including different pieces of data obtained by dividing data to be transmitted, according to the configured number of layers, to the base station 220 via the plurality of antennas 340.

The electronic device 101 may detect activation of a call service in operation 720.

The electronic device 101 may detect activation of a call service while performing cellular wireless communication in a first mode (e.g., SMDL) supporting transmission of at least two or more data layers.

According to an example, the electronic device 101 may detect activation of a call service according to execution of an application related to the call service. According to another example, the electronic device 101 may detect activation of a call service in response to receiving a signal (e.g., a paging message) indicating activation of a call service from the base station 220.

The electronic device 101 may identify whether a wearable device (e.g., a hearing aid) is adjacent to the electronic device 101 in response to detecting activation of a call service. Alternatively, the electronic device 101 may identify whether the wearable device (e.g., a hearing aid) is likely to be adjacent to the electronic device 101, in response to detecting activation of the call service. The wearable device may refer to various electronic devices that may possibly experience interference in operations of the wearable device by signals output by the electronic device 101 while the electronic device 101 performs a call service. Although a hearing aid is given as a representative example of the wearable device in the disclosure, the wearable device is not limited to a hearing aid, and may refer to various electronic devices that may possibly experience interference by signals output by the electronic device 101 while the electronic device 101 performs a call service.

For example, the electronic device 101 may identify whether a hearing aid compatibility mode is activated in the electronic device 101. Activation of the hearing aid compatibility mode in the electronic device 101 may indicate that the user of the electronic device 101 is wearing a hearing aid, and that the hearing aid is likely to be affected by signals output while a call service is performed using the electronic device 101.

In response to identifying that a hearing aid compatibility mode is activated in the electronic device 101, the electronic device 101 may perform an operation for reducing the magnitude of a magnetic field generated by output of signals via the plurality of antennas (or for reducing (or preventing) interference of a wearable device (e.g., a hearing aid)).

The electronic device 101 may identify that the base station 220 supports no configuration of cellular communication based on UE assistance information, in operation 730.

The electronic device 101 may identify whether the base station 220 supports configuration of cellular wireless communication based on UE assistance information. According to an example, the electronic device 101 may receive an RRC reconfiguration message from the base station 220 during a process of initially accessing the base station 220 (e.g., a process in which the electronic device 101 hands over from another base station to the base station 220) or a process of switching the RRC state (e.g., switching from an RRC idle state to an RRC connected state). The RRC reconfiguration message received from the base station 220 may include information indicating whether the base station 220 supports configuration of cellular wireless communication based on UE assistance information. The RRC reconfiguration message may be identical to the RRC reconfiguration message that the electronic device 101 receives from the base station 220 in operation 610.

The electronic device 101 may transmit a channel state information report that induces a transition from the first mode to the second mode to the base station 220 in operation 740.

In case that the hearing aid compatibility mode is activated in the electronic device 101, and in case that the base station 220 supports no configuration of cellular wireless communication based on UE assistance information, the electronic device 101 may perform an operation of inducing the base station 220 to control the electronic device 101 to switch from the first mode to the second mode.

For example, a situation in which the base station 220 controls the electronic device 101 to switch from the first mode to the second mode may occur in case that the quality of a channel established between the electronic device 101 and the base station 220 is low. Therefore, the electronic device 101 may control the communication circuitry 330 to transmit information indicating a quality lower (or worse) than the actual quality of the channel established (or provided/generated) between the electronic device 101 and the base station 220 to the base station 220. According to an example, the electronic device 101 may transmit a channel state information report (CSI report) including information indicating a quality lower (or worse) than the actual quality of the channel established (or provided/generated) between the electronic device 101 and the base station 220 to the base station 220.

The base station 220 may transmit, in operation 750, a signal for instructing a transition from the first mode to the second mode to the electronic device 101.

Based on the channel state information report transmitted by the electronic device 101, the base station 220 may identify that the quality between the electronic device 101 and the base station 220 is deteriorated (or poor), and may transmit, to the electronic device 101, a signal (for example, RRC reconfiguration message) instructing the electronic device 101 to switch from the first mode to the second mode. Upon receiving the signal instructing a transition from the first mode to the second mode from the base station 220, the electronic device 101 may switch from the first mode to the second mode, and may transmit one data layer including call-related packets to the base station 220.

For example, a situation in which the base station 220 controls the electronic device 101 to switch from the first mode to the second mode may occur in case that the channel established between the electronic device 101 and the base station 220 has a low quality. Therefore, the electronic device 101 may control the communication circuitry 330 to transmit a rank indicator to the base station 220 such that the value of the maximum rank supported by the electronic device 101 is configured lower than the actual value. According to an example, the electronic device 101 may transmit a channel state information report (CSI report) including a rank indicator that configures the value of the maximum rank supported by the electronic device 101 to be lower than the actual value to the base station 220. Based on the channel state information report transmitted by the electronic device 101, the base station 220 may identify that the quality between the electronic device 101 and the base station 220 is deteriorated (or poor), and transmit a signal (e.g., an RRC reconfiguration message) for instructing the electronic device 101 to switch from the first mode to the second mode to the electronic device 101. Upon receiving the signal instructing a transition from the first mode to the second mode from the base station 220, the electronic device 101 may switch from the first mode to the second mode, and may transmit one data layer including call-related packets to the base station 220.

The electronic device 101 may transmit/receive call-related packets via at least one antenna in operation 760.

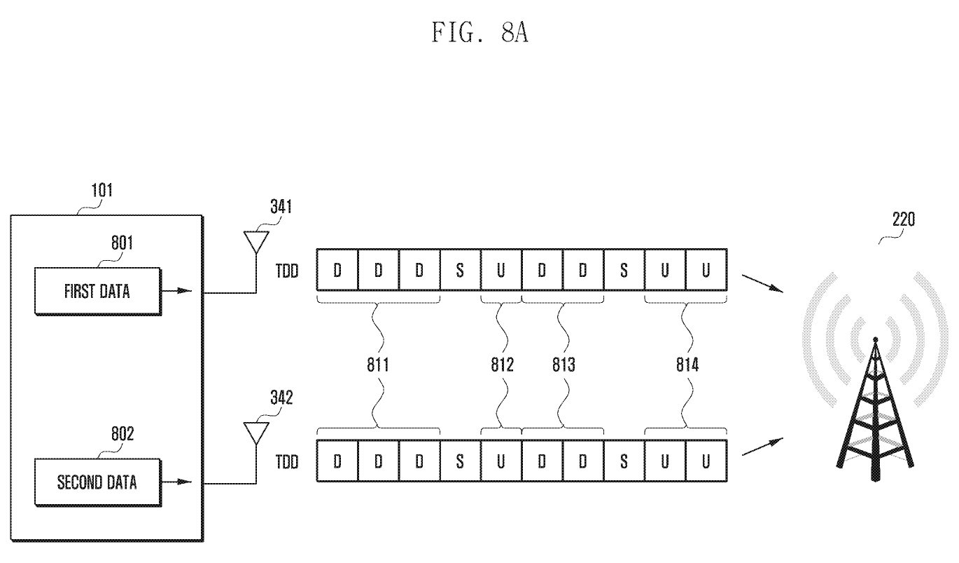

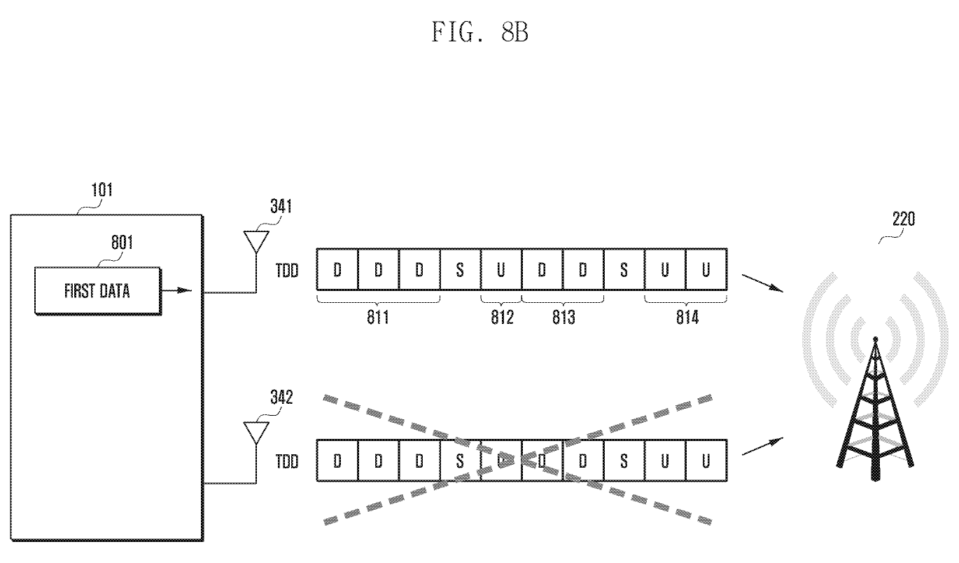

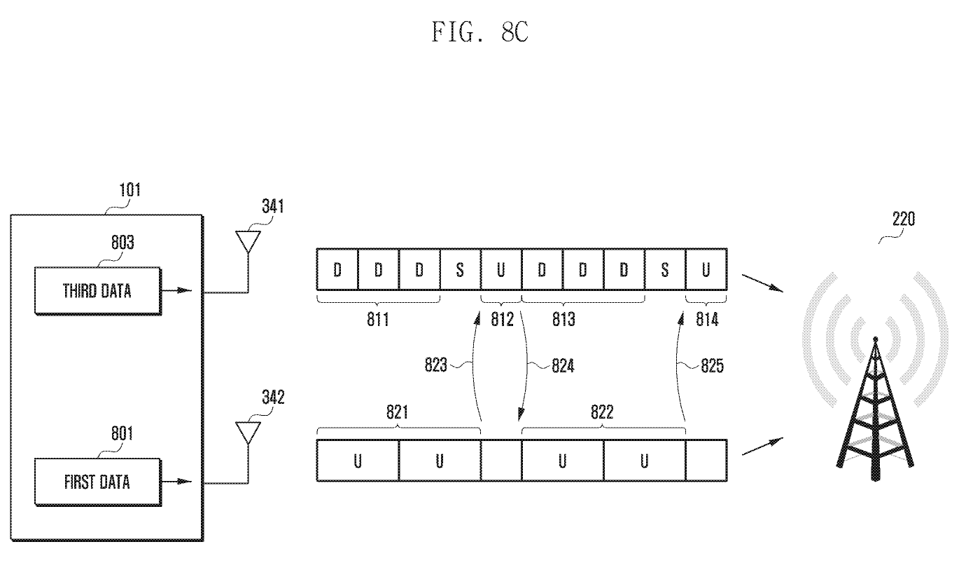

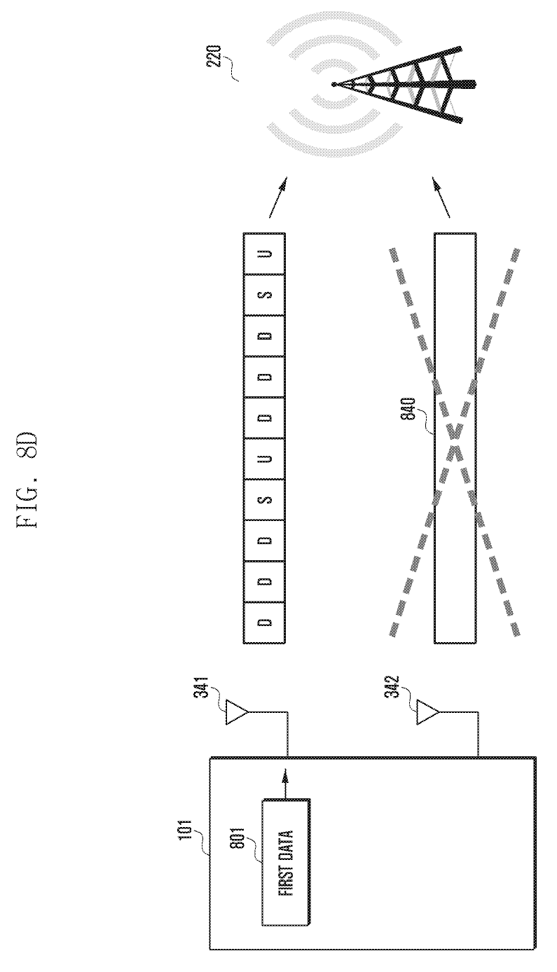

FIG. 8A is a diagram illustrating an example in which an electronic device transmits signals including different parts of data via a time division duplex channel according to an embodiment of the disclosure.

The electronic device 101 performing UL-MIMO may support various modes according to the number of layers of data transmitted by the electronic device 101. According to an example, the number of layers may refer to the number of individual data streams transmitted in case that the electronic device 101 transmits a plurality of data streams via a plurality of antennas 340. According to an example, the description that the number of layers of data is two may mean that two data streams including different pieces of data may be transmitted via the plurality of antennas 340. A mode for transmitting at least two or more data layers may be defined as a first mode. For example, the first mode may be referred to as a spatially multiplexed dual layer (SMDL) for a mode of transmitting two data layers. A mode for transmitting one data layer may be referred to as a second mode (or spatially multiplexed single layer (SMSL)).

According to an example, the electronic device 101 may perform cellular wireless communication in a first mode (e.g., SMDL) that supports transmission of at least two or more data layers. The electronic device 101 may control the communication circuitry 330 to transmit signals including different pieces of data obtained by dividing data to be transmitted, according to the configured number of layers, to the base station 220 via the plurality of antennas 340.

Referring to FIG. 8A, the electronic device 101 may transmit first data 801 and second data 802, which are generated by dividing data to be transmitted according to the configured number (e.g., 2) of layers, to the base station 220 via the first antenna 341 and the second antenna 342.

According to an example, the electronic device 101 may transmit first data 801 and second data 802 to the base station 220 via a time division duplex (TDD) channel while operating in the first mode.

According to an example, the electronic device 101 may receive, from the base station 220, schedule information regarding data transmission and/or reception via a time division duplex channel. The scheduling information may include information indicating a time slot 812 or 814 allocated to the electronic device 101 to transmit a signal to the base station 220, and information indicating a time slot 811 or 813 allocated to the electronic device 101 to receive a signal from the base station 220.

According to an example, the electronic device 101 may receive a signal from the base station 220 during a time corresponding to a time slot 811 or 813 allocated to the electronic device 101 to receive a signal from the base station 220. The electronic device 101 may have data transmission of limited (or prohibited) for a time corresponding to a time slot 811 or 813 allocated to the electronic device 101 to receive a signal from the base station 220.

According to an example, the electronic device 101 may transmit first data 901 and second data 802 to the base station 220 for a time corresponding to a time slot 812 or 814 allocated to the electronic device 101 to transmit a signal to the base station 220. The electronic device 101 may transmit a signal including a part of the first data 801 to the base station 220 via the first antenna 341 for a time corresponding to a time slot 812 allocated for the electronic device 101 to transmit a signal to the base station 220, and the electronic device 101 may transmit a signal including the remaining part of the first data 801 to the base station 220 via the first antenna 341 for a time corresponding to a time slot 814 allocated for the electronic device 101 to transmit a signal to the base station 220.

The electronic device 101 may transmit a signal including a part of the second data 802, to the base station 220 via the second antenna 342 for a time corresponding to a time slot 812 allocated to the electronic device 101 to transmit a signal to the base station 220, and the electronic device 101 may transmit a signal including the remaining part of the second data 802 to the base station 220 via the second antenna 342 for a time corresponding to a time slot 814 allocated to the electronic device 101 to transmit a signal to the base station 220.

FIG. 8B is a diagram illustrating an example in which an electronic device transmits a signal including data via a time division duplex channel according to an embodiment of the disclosure.

The electronic device (e.g., the electronic device 101 in FIG. 3) may switch from a first mode to a second mode in case that a hearing aid compatibility mode is activated in the electronic device 101, and in case that the base station 220 supports configuration of cellular wireless communication based on a voice priority mode or UE assistance information. The second mode may refer to a mode in which a signal including data to be transmitted is transmitted via at least one antenna (e.g., the first antenna 341 or the second antenna 342 in FIG. 8A) among a plurality of antennas (e.g., a plurality of antennas 340 in FIG. 3).

As described above with reference to FIGS. 3 to 7, the electronic device 101 may switch from the first mode to the second mode by transmitting information indicating that the hearing aid compatibility mode is activated to the base station 220 supporting the voice priority mode, by transmitting UE assistance information in which the maximum number of MIMO layers supported by the electronic device 101 is configured to be 1 to the base station 220 supporting configuration of cellular wireless communication based on UE assistance information, by transmitting channel state information (CSI) indicating that the quality of the channel between the electronic device 101 and the base station 220 is poor to the base station 220, and/or by transmitting channel state information including a rank indicator in which the maximum rank supported by the electronic device 101 is configured to be 1 to the base station 220.

The electronic device 101 may transmit data (e.g., first data 801) to be transmitted to the base station 220 via a time division duplex (TDD) channel, in response to switching from the first mode to the second mode.

According to an example, the electronic device 101 may transmit first data 801 to the base station 220 during a time corresponding to a time slot 812 or 814 allocated to the electronic device 101 to transmit a signal to the base station 220. The electronic device 101 may transmit a signal including a part of the first data 801 to the base station 220 via the first antenna 341 for a time corresponding to a time slot 812 allocated for the electronic device 101 to transmit a signal to the base station 220, and the electronic device 101 may transmit a signal including the remaining part of the first data 801 to the base station 220 via the first antenna 341 for a time corresponding to a time slot 814 allocated for the electronic device 101 to transmit a signal to the base station 220.

According to an example, the electronic device 101 may reduce the magnitude of the magnetic field generated by a change in signal output by transmitting no data to the base station 220 via the second antenna 342.

FIG. 8C is a diagram illustrating an example in which an electronic device transmits signals via a time division duplex channel and a frequency division duplex channel according to an embodiment of the disclosure.

The electronic device (e.g., the electronic device 101 in FIG. 3) may switch from a first mode to a second mode in case that a hearing aid compatibility mode is activated in the electronic device 101, and in case that the base station 220 supports configuration of cellular wireless communication based on a voice priority mode or UE assistance information. The second mode may refer to a mode in which a signal including data to be transmitted is transmitted via at least one antenna (e.g., the first antenna 341 or the second antenna 342 in FIG. 8A) among a plurality of antennas (e.g., a plurality of antennas 340 in FIG. 3).

As described above with reference to FIGS. 3 to 7, the electronic device 101 may switch from the first mode to the second mode by transmitting information indicating that the hearing aid compatibility mode is activated to the base station 220 supporting the voice priority mode, by transmitting UE assistance information in which the maximum number of MIMO layers supported by the electronic device 101 is configured to be 1 to the base station 220 supporting configuration of cellular wireless communication based on UE assistance information, by transmitting channel state information (CSI) indicating that the quality of the channel between the electronic device 101 and the base station 220 is poor to the base station 220, and/or by transmitting channel state information including a rank indicator in which the maximum rank supported by the electronic device 101 is configured to be 1 to the base station 220.

The electronic device 101 may transmit data to be transmitted (for example, first data 801 and third data 803) to the base station 220 via a time division duplex (TDD) channel and a frequency division duplex (FDD) channel according to a transition from the first mode to the second mode.

The electronic device 101 may activate uplink carrier aggregation in accordance with the state of the electronic device 101 satisfying a first condition. The uplink carrier aggregation may refer to the electronic device 101 transmitting signals to the base station 220 via at least two channels. According to an example, the electronic device 101 may transmit signals to the base station 220 via a frequency division duplex (FDD) channel and a time division duplex (TDD) channel, based on the state of the electronic device 101 satisfying a first condition.

According to an example, the first condition may refer to a condition that the required throughput of a service performed together while the electronic device 101 performs a telephone service is equal to or greater than (or exceeds) a specified size. For example, the first condition may include a condition that the required throughput of a specific application currently running on the electronic device 101 is equal to or greater (or exceeds) a designated size.

In order to perform uplink carrier aggregation using a frequency division duplex channel and a time division duplex channel, the electronic device 101 may transmit a signal (e.g., DCI) for requesting timing information for switching from signal transmission via a frequency division duplex channel to signal transmission via a time division duplex channel (or timing information for switching from signal transmission via a time division duplex channel to signal transmission via a frequency division duplex channel) to the base station 220. The base station 220 may transmit a signal (e.g., DCI) including timing information for switching from signal transmission via a frequency division duplex channel to signal transmission via a time division duplex channel (or timing information for switching from signal transmission via a time division duplex channel to signal transmission via a frequency division duplex channel) and scheduling information regarding data transmission and/or reception via a time division duplex channel to the electronic device 101.

The electronic device 101 may transmit a part of the first data 801 to the base station 220 via a frequency division duplex channel. The electronic device 101 may transmit a part of the first data 801 to the base station 220 via a frequency division duplex channel for a time 821 before the arrival of a timepoint 823 of switching from signal transmission via a frequency division duplex channel to signal transmission via a time division duplex channel, included timing information received from the base station 220.

The electronic device 101 may transmit a part of third data 803 to the base station 220 via a time division duplex channel at a timepoint 823 to switch from signal transmission via a frequency division duplex channel to signal transmission via a time division duplex channel. The electronic device 101 may transmit a part of the third data 803 to the base station 220 via a time division duplex channel for a time corresponding to a time slot 812 allocated for signal transmission via a frequency division duplex channel included in schedule information. The electronic device 101 may prohibit (or restrict) data transmission via a frequency division duplex channel while transmitting a part of the third data 803 via a time division duplex channel.

The electronic device 101 may transmit the remaining part of the first data 801 to the base station 220 via a frequency division duplex channel during a period 822 after a timepoint 824 to switch from signal transmission via a time division duplex channel to signal transmission via a frequency division duplex channel. The electronic device 101 may transmit the remaining part of the third data 803 to the base station 220 via a time division duplex channel at a timepoint 825 to switch from signal transmission via a frequency division duplex channel to signal transmission via a time division duplex channel. The electronic device 101 may transmit a part of the third data 803 to the base station 220 via a time division duplex channel for a time corresponding to a time slot 814 allocated for signal transmission via a frequency division duplex channel included in schedule information.

FIG. 8D is a diagram illustrating an example in which an electronic device transmits signals via a frequency division duplex channel according to an embodiment of the disclosure.

The electronic device 101 may transmit signals to the base station 220 via a frequency division duplex channel, not a time division duplex channel activated in a first mode, in accordance with the state of the electronic device 101 satisfying a second condition.

According to an example, the second condition may refer to a condition indicating that the interference applied to the wearable device (or the hearing aid) is substantial. Alternatively, the second condition may include a condition in which the quality of a channel between the electronic device 101 and the base station 220 is relatively good.

According to an example, the electronic device 101 may perform an operation of inducing a transition from a time division duplex channel to a frequency division duplex channel, based on the state of the electronic device 101 satisfying the second condition. For example, the electronic device 101 may switch to a frequency division duplex channel by transmitting a measurement report in which the quality of a time division duplex channel is configured to be lower than the actual quality to the base station 220.

The electronic device 101 may transmit first data 801 to the base station 220 via a frequency division duplex channel 840.

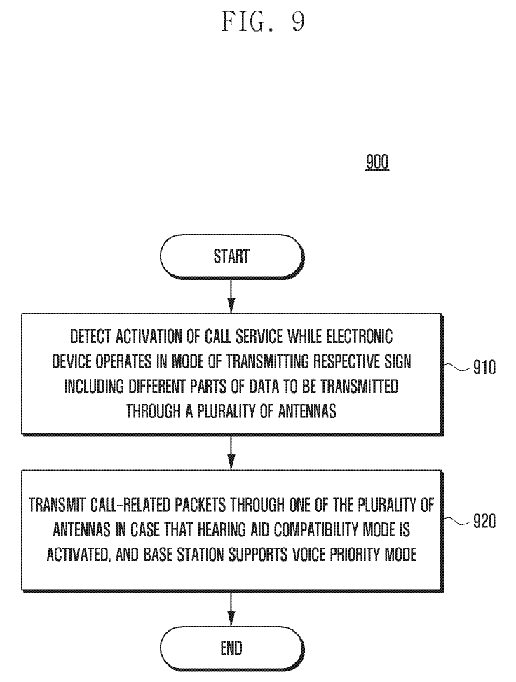

FIG. 9 is a flowchart illustrating an operation method of an electronic device according to an embodiment of the disclosure.

Referring to flowchart 900 of FIG. 9, the electronic device (for example, the electronic device 101 in FIG. 3) may detect activation of a call service while the electronic device 101 operates in a first mode of transmitting respective signals including different parts of data to be transmitted via a plurality of antennas, in operation 910.

The electronic device 101 may receive an RRC reconfiguration message from the base station 220 and perform cellular communication using a plurality of antennas 340, based on information related to a signal transmission scheme using a plurality of antennas 340 included in the RRC reconfiguration message.

According to an example, in case that the base station 220 (or the cellular network) supports uplink multiple-input multiple-output (UL-MIMO), the electronic device 101 may receive an RRC reconfiguration message including a configuration related to the UL-MIMO. According to an example, the configuration related to UL-MIMO may include at least one of whether the UL-MIMO is activated, the number of antennas that may be used by the electronic device 101 to transmit signals to the base station 220, or the number of layers (Tx layers) of data to be transmitted by the electronic device 101 to the base station 220.

The electronic device 101 may receive an RRC reconfiguration message including a configuration related to UL-MIMO from the base station 220, and transmit signals via a plurality of antennas 340, based on the configuration related to UL-MIMO. In case that the electronic device 101 performs UL-MIMO, data included in a signal output via one of the plurality of antennas 340 and data included in a signal output via another of the plurality of antennas 340 may differ from each other. The electronic device 101 may improve the data transmission rate (or throughput) by transmitting respective signals including different parts of data to be transmitted to the base station 220 via the plurality of antennas 340. The electronic device 101 performing UL-MIMO may support various modes according to the number of layers of data transmitted by the electronic device 101. According to an example, the number of layers may refer to the number of individual data streams transmitted in case that the electronic device 101 transmits a plurality of data streams via a plurality of antennas 340. According to an example, the description that the number of layers of data is two may mean that two data streams including different pieces of data may be transmitted via the plurality of antennas 340. A mode for transmitting at least two or more data layers may be defined as a first mode. A mode for transmitting two data layers may be referred to as a spatially multiplexed dual layer (SMDL). A mode for transmitting one data layer may be referred to as a second mode (or spatially multiplexed single layer (SMSL)).

According to an example, the electronic device 101 may perform cellular wireless communication in a first mode (e.g., SMDL) that supports transmission of at least two or more data layers. The electronic device 101 may control the communication circuitry 330 to transmit signals including different pieces of data obtained by dividing data to be transmitted, according to the configured number of layers, to the base station 220 via the plurality of antennas 340.

The electronic device 101 may detect activation of a call service while performing cellular wireless communication in a first mode (e.g., SMDL) supporting transmission of at least two or more data layers.

According to an example, the electronic device 101 may detect activation of a call service according to execution of an application related to the call service. According to another example, the electronic device 101 may detect activation of a call service in response to receiving a signal (e.g., a paging message) indicating activation of a call service from the base station 220.

The electronic device 101 may identify whether a wearable device (e.g., a hearing aid) is adjacent to the electronic device 101 in response to detecting activation of a call service. Alternatively, the electronic device 101 may identify whether the wearable device (e.g., a hearing aid) is likely to be adjacent to the electronic device 101, in response to detecting activation of the call service. The wearable device may refer to various electronic devices that may possibly experience interference in operations of the wearable device by signals output by the electronic device 101 while the electronic device 101 performs a call service. Although a hearing aid is given as a representative example of the wearable device in the disclosure, the wearable device is not limited to a hearing aid, and may refer to various electronic devices that may possibly experience interference by signals output by the electronic device 101 while the electronic device 101 performs a call service.

The electronic device 101 may transmit a signal including call-related packets via one of the plurality of antennas in operation 920, in case that the hearing aid compatibility mode is activated, and in case that the base station supports the voice priority mode.

For example, the electronic device 101 may identify whether the hearing aid compatibility mode is activated in the electronic device 101. Activation of the hearing aid compatibility mode in the electronic device 101 may indicate that the user of the electronic device 101 is wearing a hearing aid, and that the hearing aid is likely to be affected by signals output while a call service is performed using the electronic device 101.

In response to identifying that the hearing aid compatibility mode is activated in the electronic device 101, the electronic device 101 may perform an operation for reducing the magnitude of a magnetic field generated by output of signals via the plurality of antennas (or for reducing (or preventing) interference of a wearable device (e.g., a hearing aid)).

The electronic device 101 may identify whether the base station 220 supports a voice priority mode in which call-related packets are transmitted with higher priority than other packets. According to an example, the electronic device 101 may receive an RRC reconfiguration message from the base station 220 during a process of initially accessing the base station 220 (e.g., a process in which the electronic device 101 hands over from another base station to the base station 220) or a process of switching the RRC state (e.g., switching from an RRC idle state to an RRC connected state). The RRC reconfiguration message received from the base station 220 may include information indicating whether the base station 220 supports the voice priority mode. The voice priority mode may refer to a mode in which the base station 220 or the electronic device 101 preferentially processes transmission and/or reception of call-related packets, as compared to transmission and/or reception of other types of packets (e.g., packets including user data). The base station 220 supporting the voice priority mode may reduce the delay time of transmission and/or reception of call-related packets as compared to base stations not supporting the voice priority mode.

In case that the base station 220 supporting the voice priority mode receives a specific signal (e.g., information indicating that the hearing aid compatibility mode is activated) from the electronic device 101, the base station 220 may transmit one data layer to the electronic device 101, when transmitting call-related packets, even if the electronic device 101 is configured to operate in a mode of transmitting a plurality of data layers.

The electronic device 101 may identify whether the base station 220 supports the voice priority mode, based on the information indicating whether the voice priority mode is supported, which is included in the RRC reconfiguration message received from the base station 220.

In case that the hearing aid compatibility mode is activated in the electronic device 101, and in case that the base station 220 supports the voice priority mode in which call-related packets are transmitted and/or received with higher priority than other packets, the electronic device 101 may control the communication circuitry 330 to transmit call-related packets to the base station 220 via at least one of the plurality of antennas 340.

In order to transmit call-related packets to the base station 220 via at least one of the plurality of antennas 340, the electronic device 101 may reduce the number of layers of data streams transmitted to the base station 220. The reduced number of layers of data streams transmitted to the base station 220 may refer to a possible reduction in the number of antennas used by the electronic device 101 to transmit signals to the base station 220. Reducing the number of antennas used to transmit signals may reduce the magnitude of a magnetic field generated by a change in signal output. The reduced magnitude of the magnetic field may reduce the interference experienced by the wearable device due to signals output by the electronic device 101.

According to an example, in a situation in which the electronic device 101 performs UL-MIMO via a TDD channel, reducing the number of layers of data streams may reduce the change in strength of signals that are output, thereby reducing the magnitude of the magnetic field.

The electronic device 101 may transmit one data stream to the base station 220 via one of the plurality of antennas 340 in case that the hearing aid compatibility mode is activated, even if the number of data streams configured by the base station 220 is at least two or more. A mode in which one data stream is transmitted to the base station 220 via at least one of the plurality of antennas 340 may be defined as a second mode. Upon receiving information indicating that the hearing aid compatibility mode is activated in the electronic device 101, the electronic device 101 and the base station 220 may preconfigure a rule instructing the electronic device 101 to transmit one data stream to the base station 220, even if the number of data streams configured by the base station 220 is at least two or more.

The electronic device 101 may transmit information indicating that the hearing aid compatibility mode is activated in the electronic device 101 to the base station 220, and then transmit call-related packets to the base station 220 via at least one of the plurality of antennas 340.

According to an example, a call-related packet may be implemented as one data layer and then transmitted to the base station 220. The electronic device 101 may transmit call-related packets via two or more antennas. However, respective signals output via two or more antennas may be configured to include the same data.

Upon receiving, from the electronic device 101, information indicating that a hearing aid compatibility mode is activated in the electronic device 101, the base station 220 may activate the voice priority mode. The activation of the voice priority mode by the base station 220 may refer to a configuration for preferentially transmitting call-related packets, as compared to other packets. The base station 220 may preferentially transmit call-related packets to the electronic device 101, and transmit other packets to the electronic device 101 after the call-related packets are transmitted. In connection with transmitting call-related packets, the base station 220 may configure the number of layers of the data stream to be reduced. According to an example, upon receiving information indicating that the hearing aid compatibility mode is activated in the electronic device 101 from the electronic device 101, the base station 220 may reduce the number of layers of the data stream to one (or switch to the second mode).

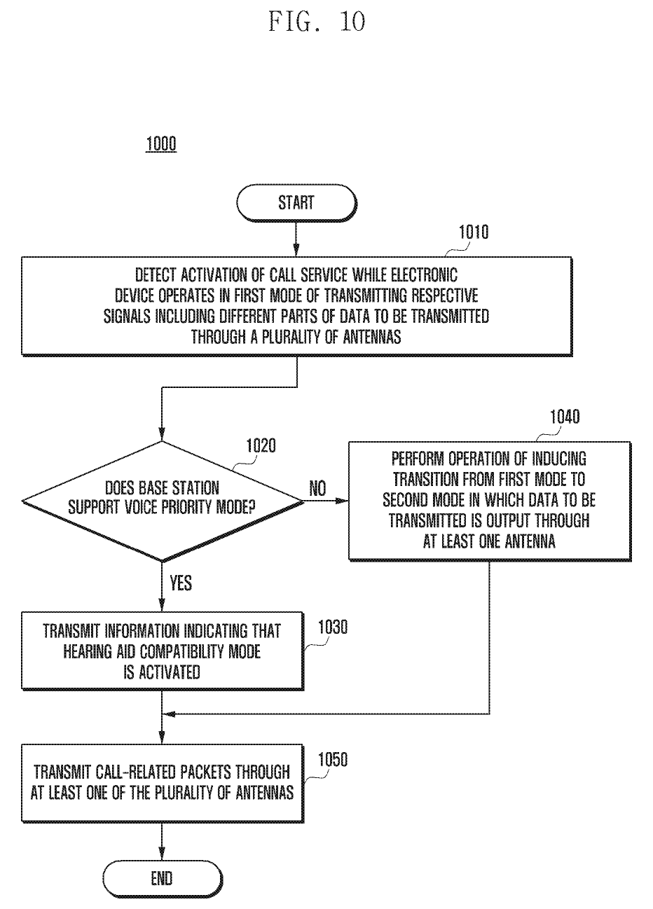

FIG. 10 is a flowchart illustrating an operation method of an electronic device according to an embodiment of the disclosure.

Referring to flowchart 1000 of FIG. 10, the electronic device (for example, the electronic device 101 in FIG. 3) may detect activation of a call service while the electronic device 101 operates in a first mode of transmitting respective signals including different parts of data to be transmitted via a plurality of antennas, in operation 1010.

The electronic device 101 may receive an RRC reconfiguration message from the base station 220 and perform cellular communication using a plurality of antennas 340, based on information related to a signal transmission scheme using a plurality of antennas 340 included in the RRC reconfiguration message.

According to an example, in case that the base station 220 (or the cellular network) supports uplink multiple-input multiple-output (UL-MIMO), the electronic device 101 may receive an RRC reconfiguration message including a configuration related to the UL-MIMO. According to an example, the configuration related to UL-MIMO may include at least one of whether the UL-MIMO is activated, the number of antennas that may be used by the electronic device 101 to transmit signals to the base station 220, or the number of layers (Tx layers) of data to be transmitted by the electronic device 101 to the base station 220.

The electronic device 101 may receive an RRC reconfiguration message including a configuration related to UL-MIMO from the base station 220, and transmit signals via a plurality of antennas 340, based on the configuration related to UL-MIMO. In case that the electronic device 101 performs UL-MIMO, data included in a signal output via one of the plurality of antennas 340 and data included in a signal output via another of the plurality of antennas 340 may differ from each other. The electronic device 101 may improve the data transmission rate (or throughput) by transmitting respective signals including different parts of data to be transmitted to the base station 220 via the plurality of antennas 340.

The electronic device 101 performing UL-MIMO may support various modes according to the number of layers of data transmitted by the electronic device 101. According to an example, the number of layers may refer to the number of individual data streams transmitted in case that the electronic device 101 transmits a plurality of data streams via a plurality of antennas 340. According to an example, the description that the number of layers of data is two may mean that two data streams including different pieces of data may be transmitted via the plurality of antennas 340. A mode for transmitting at least two or more data layers may be defined as a first mode. A mode for transmitting two data layers may be referred to as a spatially multiplexed dual layer (SMDL). A mode for transmitting one data layer may be referred to as a second mode (or spatially multiplexed single layer (SMSL)).

According to an example, the electronic device 101 may perform cellular wireless communication in a first mode (e.g., SMDL) that supports transmission of at least two or more data layers. The electronic device 101 may control the communication circuitry 330 to transmit signals including different pieces of data obtained by dividing data to be transmitted, according to the configured number of layers, to the base station 220 via the plurality of antennas 340.

The electronic device 101 may detect activation of a call service while performing cellular wireless communication in a first mode (e.g., SMDL) supporting transmission of at least two or more data layers.

According to an example, the electronic device 101 may detect activation of a call service according to execution of an application related to the call service. According to another example, the electronic device 101 may detect activation of a call service in response to receiving a signal (e.g., a paging message) indicating activation of a call service from the base station 220.

The electronic device 101 may identify whether a wearable device (e.g., a hearing aid) is adjacent to the electronic device 101 in response to detecting activation of a call service. Alternatively, the electronic device 101 may identify whether the wearable device (e.g., a hearing aid) is likely to be adjacent to the electronic device 101, in response to detecting activation of the call service. The wearable device may refer to various electronic devices that may possibly experience interference in operations of the wearable device by signals output by the electronic device 101 while the electronic device 101 performs a call service. Although a hearing aid is given as a representative example of the wearable device in the disclosure, the wearable device is not limited to a hearing aid, and may refer to various electronic devices that may possibly experience interference by signals output by the electronic device 101 while the electronic device 101 performs a call service.

The electronic device 101 may identify whether the base station 220 supports a voice priority mode in operation 1020.

The electronic device 101 may identify whether the base station 220 supports a voice priority mode in which call-related packets are transmitted with higher priority than other packets.

According to an example, the electronic device 101 may identify whether the base station 220 supports the voice priority mode with reference to data, to which information of the network operator operating the base station 220 and information indicating whether the network operator supports the voice priority mode, are mapped.

According to an example, the electronic device 101 may receive an RRC reconfiguration message from the base station 220 during a process of initially accessing the base station 220 (e.g., a process in which the electronic device 101 hands over from another base station to the base station 220) or a process of switching the RRC state (e.g., switching from an RRC idle state to an RRC connected state). The RRC reconfiguration message received from the base station 220 may include information indicating whether the base station 220 supports the voice priority mode. The voice priority mode may refer to a mode in which the base station 220 or the electronic device 101 preferentially processes transmission and/or reception of call-related packets, as compared to transmission and/or reception of other types of packets (e.g., packets including user data). The base station 220 supporting the voice priority mode may reduce the delay time of transmission and/or reception of call-related packets as compared to base stations not supporting the voice priority mode.

In operation 1030, the electronic device 101 may transmit information indicating that the hearing aid compatibility mode is activated to the base station 220 in case that the base station supports the voice priority mode (Yes in operation 1020).

In case that the base station 220 supporting the voice priority mode receives a specific signal (e.g., information indicating that the hearing aid compatibility mode is activated) from the electronic device 101, the base station 220 may transmit one data layer to the electronic device 101, when transmitting call-related packets, even if the electronic device 101 is configured to operate in a mode of transmitting a plurality of data layers.

In operation 1040, the electronic device 101 may perform an operation of inducing a transition from the first mode to the second mode in which data to be transmitted is output via at least one antenna, in case that the base station does not support the voice priority mode (No in operation 1020).

In case that the hearing aid compatibility mode is activated in the electronic device 101, and in case that the base station 220 does not support the voice priority mode in which call-related packets are transmitted and/or received with higher priority than other packets, the electronic device 101 may perform an operation of inducing the base station 220 to control the electronic device 101 to switch from the first mode to the second mode.

For example, a situation in which the base station 220 controls the electronic device 101 to switch from the first mode to the second mode may occur in case that the quality of a channel established between the electronic device 101 and the base station 220 is low. Therefore, the electronic device 101 may control the communication circuitry 330 to transmit information indicating a quality lower (or worse) than the actual quality of the channel established (or provided/generated) between the electronic device 101 and the base station 220 to the base station 220. According to an example, the electronic device 101 may transmit a channel state information report (CSI report) including information indicating a quality lower (or worse) than the actual quality of the channel established (or provided/generated) between the electronic device 101 and the base station 220 to the base station 220. Based on the channel state information report transmitted by the electronic device 101, the base station 220 may identify that the quality between the electronic device 101 and the base station 220 is deteriorated (or poor), and may transmit, to the electronic device 101, a signal (for example, RRC reconfiguration message) instructing the electronic device 101 to switch from the first mode to the second mode. Upon receiving the signal instructing a transition from the first mode to the second mode from the base station 220, the electronic device 101 may switch from the first mode to the second mode, and may transmit one data layer including call-related packets to the base station 220.

For example, a situation in which the base station 220 controls the electronic device 101 to switch from the first mode to the second mode may occur in case that the channel established between the electronic device 101 and the base station 220 has a low quality. Therefore, the electronic device 101 may control the communication circuitry 330 to transmit a rank indicator to the base station 220 such that the value of the maximum rank supported by the electronic device 101 is configured lower than the actual value. According to an example, the electronic device 101 may transmit a channel state information report (CSI report) including a rank indicator that configures the value of the maximum rank supported by the electronic device 101 to be lower than the actual value to the base station 220. Based on the channel state information report transmitted by the electronic device 101, the base station 220 may identify that the quality between the electronic device 101 and the base station 220 is deteriorated (or poor), and transmit a signal (e.g., an RRC reconfiguration message) for instructing the electronic device 101 to switch from the first mode to the second mode to the electronic device 101. Upon receiving the signal instructing a transition from the first mode to the second mode from the base station 220, the electronic device 101 may switch from the first mode to the second mode, and may transmit one data layer including call-related packets to the base station 220.

The electronic device 101 may transmit call-related packets to the base station 220 via at least one of the plurality of antennas in operation 1050.

In case that the hearing aid compatibility mode is activated in the electronic device 101, and in case that the base station 220 supports the voice priority mode in which call-related packets are transmitted and/or received with higher priority than other packets, or in the case of a transition from the first mode to the second mode, the electronic device 101 may control the communication circuitry 330 to transmit call-related packets to the base station 220 via at least one of the plurality of antennas 340.

In order to transmit call-related packets to the base station 220 via at least one of the plurality of antennas 340, the electronic device 101 may reduce the number of layers of data streams transmitted to the base station 220. The reduced number of layers of data streams transmitted to the base station 220 may refer to a possible reduction in the number of antennas used by the electronic device 101 to transmit signals to the base station 220. Reducing the number of antennas used to transmit signals may reduce the magnitude of a magnetic field generated by a change in signal output. The reduced magnitude of the magnetic field may reduce the interference experienced by the wearable device due to signals output by the electronic device 101.

According to an example, in a situation in which the electronic device 101 performs UL-MIMO via a TDD channel, reducing the number of layers of data streams may reduce the change in strength of signals that are output, thereby reducing the magnitude of the magnetic field.

The electronic device 101 may transmit one data stream to the base station 220 via one of the plurality of antennas 340 in case that the hearing aid compatibility mode is activated, even if the number of data streams configured by the base station 220 is at least two or more. A mode in which one data stream is transmitted to the base station 220 via at least one of the plurality of antennas 340 may be defined as a second mode. Upon receiving information indicating that the hearing aid compatibility mode is activated in the electronic device 101, the electronic device 101 and the base station 220 may preconfigure a rule instructing the electronic device 101 to transmit one data stream to the base station 220, even if the number of data streams configured by the base station 220 is at least two or more.

The electronic device 101 may transmit information indicating that the hearing aid compatibility mode is activated in the electronic device 101 to the base station 220, and then transmit call-related packets to the base station 220 via at least one of the plurality of antennas 340.

According to an example, a call-related packet may be implemented as one data layer and then transmitted to the base station 220. The electronic device 101 may transmit call-related packets via two or more antennas. However, respective signals output via two or more antennas may be configured to include the same data.

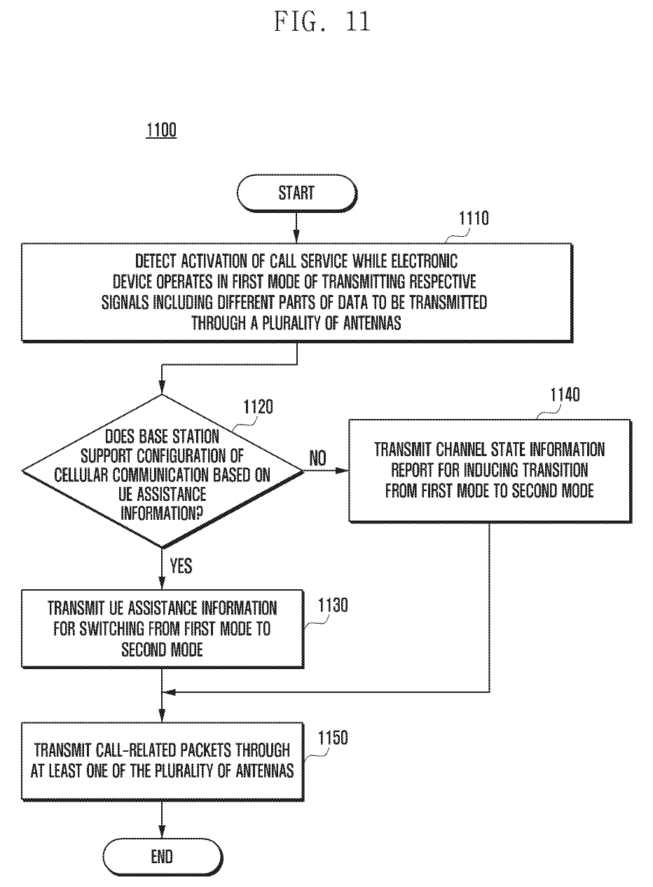

FIG. 11 is a flowchart illustrating an operation method of an electronic device according to an embodiment of the disclosure.

Referring to flowchart 1100 of FIG. 11, the electronic device (for example, the electronic device 101 in FIG. 3) may detect activation of a call service while the electronic device 101 operates in a first mode of transmitting respective signals including different parts of data to be transmitted via a plurality of antennas, in operation 1110.

The electronic device 101 may receive an RRC reconfiguration message from the base station 220 and perform cellular communication using a plurality of antennas 340, based on information related to a signal transmission scheme using a plurality of antennas 340 included in the RRC reconfiguration message.

According to an example, in case that the base station 220 (or the cellular network) supports uplink multiple-input multiple-output (UL-MIMO), the electronic device 101 may receive an RRC reconfiguration message including a configuration related to the UL-MIMO. According to an example, the configuration related to UL-MIMO may include at least one of whether the UL-MIMO is activated, the number of antennas that may be used by the electronic device 101 to transmit signals to the base station 220, or the number of layers (Tx layers) of data to be transmitted by the electronic device 101 to the base station 220.

The electronic device 101 may receive an RRC reconfiguration message including a configuration related to UL-MIMO from the base station 220, and transmit signals via a plurality of antennas 340, based on the configuration related to UL-MIMO. In case that the electronic device 101 performs UL-MIMO, data included in a signal output via one of the plurality of antennas 340 and data included in a signal output via another of the plurality of antennas 340 may differ from each other. The electronic device 101 may improve the data transmission rate (or throughput) by transmitting respective signals including different parts of data to be transmitted to the base station 220 via the plurality of antennas 340.

The electronic device 101 performing UL-MIMO may support various modes according to the number of layers of data transmitted by the electronic device 101. According to an example, the number of layers may refer to the number of individual data streams transmitted in case that the electronic device 101 transmits a plurality of data streams via a plurality of antennas 340. According to an example, the description that the number of layers of data is two may mean that two data streams including different pieces of data may be transmitted via the plurality of antennas 340. A mode for transmitting at least two or more data layers may be defined as a first mode. A mode for transmitting two data layers may be referred to as a spatially multiplexed dual layer (SMDL). A mode for transmitting one data layer may be referred to as a second mode (or spatially multiplexed single layer (SMSL)).

According to an example, the electronic device 101 may perform cellular wireless communication in a first mode (e.g., SMDL) that supports transmission of at least two or more data layers. The electronic device 101 may control the communication circuitry 330 to transmit signals including different pieces of data obtained by dividing data to be transmitted, according to the configured number of layers, to the base station 220 via the plurality of antennas 340.

The electronic device 101 may detect activation of a call service while performing cellular wireless communication in a first mode (e.g., SMDL) supporting transmission of at least two or more data layers.

According to an example, the electronic device 101 may detect activation of a call service according to execution of an application related to the call service. According to another example, the electronic device 101 may detect activation of a call service in response to receiving a signal (e.g., a paging message) indicating activation of a call service from the base station 220.

The electronic device 101 may identify whether a wearable device (e.g., a hearing aid) is adjacent to the electronic device 101 in response to detecting activation of a call service. Alternatively, the electronic device 101 may identify whether the wearable device (e.g., a hearing aid) is likely to be adjacent to the electronic device 101, in response to detecting activation of the call service. The wearable device may refer to various electronic devices that may possibly experience interference in operations of the wearable device by signals output by the electronic device 101 while the electronic device 101 performs a call service. Although a hearing aid is given as a representative example of the wearable device in the disclosure, the wearable device is not limited to a hearing aid, and may refer to various electronic devices that may possibly experience interference by signals output by the electronic device 101 while the electronic device 101 performs a call service.

The electronic device 101 may identify whether the base station 220 supports configuration of cellular communication based on UE assistance information, in operation 1120.

The electronic device 101 may receive an RRC reconfiguration message from the base station 220 and then transmit, to the base station 220, UE assistance information including configuration (e.g., the maximum number of layers used for UL-MIMO or DL-MIMO) of cellular wireless communication supportable by the electronic device 101. The base station 220 may configure cellular wireless communication in consideration of configuration of the cellular wireless communication supportable by the electronic device 101 included in the UE assistance information. For example, the base station 220 supporting configuration of cellular wireless communication based on UE assistance information may configure the same number of data layers as the maximum number of layers that may be used for UL-MIMO or DL-MIMO included in the UE assistance information, and may transmit an RRC reconfiguration message including information indicating the number of configured data layers to the electronic device 101.

The electronic device 101 may identify whether the base station 220 supports configuration of cellular wireless communication based on UE assistance information. According to an example, the electronic device 101 may receive an RRC reconfiguration message from the base station 220 during a process of initially accessing the base station 220 (e.g., a process in which the electronic device 101 hands over from another base station to the base station 220) or a process of switching the RRC state (e.g., switching from an RRC idle state to an RRC connected state). The RRC reconfiguration message received from the base station 220 may include information indicating whether the base station 220 supports configuration of cellular wireless communication based on UE assistance information.

In operation 1130, the electronic device 101 may transmit UE assistance information for switching from the first mode to the second mode to the base station 220, based on the base station 220 supporting configuration of cellular communication based on UE assistance information (Yes in operation 1120).

In case that the hearing aid compatibility mode is activated in the electronic device 101, and in case that the base station 220 supports configuration of cellular wireless communication based on UE assistance information, electronic device 101 may transmit UE assistance information to the base station 220 so as to switch from the first mode to the second mode. As described above, the first mode may refer to a mode (e.g., SMDL) in which signals including different parts of data to be transmitted are transmitted via a plurality of antennas, and the second mode may refer to a mode (e.g., SMSL) in which a signal including data to be transmitted is transmitted via at least one antenna among a plurality of antennas.

The UE assistance information for switching from the first mode to the second mode may be included in a field indicating the maximum number of layers of MIMO among fields included in the UE assistance information (e.g., maximum number of MIMO layers). According to an example, the electronic device 101 may transmit UE assistance information in which the maximum number of MIMO layers is set to 1 to the base station 220, thereby inducing the base station 220 to control the electronic device 101 to switch from the first mode to the second mode.

In operation 1140, the electronic device 101 may transmit a channel state information report for inducing a transition from the first mode to the second mode to the base station 220, based on the base station 220 supporting no configuration of cellular communication based on the UE assistance information (No in operation 1120).

In case that the hearing aid compatibility mode is activated in the electronic device 101, and in case that the base station 220 supports no configuration of cellular wireless communication based on UE assistance information, the electronic device 101 may perform an operation of inducing the base station 220 to control the electronic device 101 to switch from the first mode to the second mode.

For example, a situation in which the base station 220 controls the electronic device 101 to switch from the first mode to the second mode may occur in case that the quality of a channel established between the electronic device 101 and the base station 220 is low. Therefore, the electronic device 101 may control the communication circuitry 330 to transmit information indicating a quality lower (or worse) than the actual quality of the channel established (or provided/generated) between the electronic device 101 and the base station 220 to the base station 220. According to an example, the electronic device 101 may transmit a channel state information report (CSI report) including information indicating a quality lower (or worse) than the actual quality of the channel established (or provided/generated) between the electronic device 101 and the base station 220 to the base station 220. Based on the channel state information report transmitted by the electronic device 101, the base station 220 may identify that the quality between the electronic device 101 and the base station 220 is deteriorated (or poor), and may transmit, to the electronic device 101, a signal (for example, RRC reconfiguration message) instructing the electronic device 101 to switch from the first mode to the second mode. Upon receiving the signal instructing a transition from the first mode to the second mode from the base station 220, the electronic device 101 may switch from the first mode to the second mode, and may transmit one data layer including call-related packets to the base station 220.

For example, a situation in which the base station 220 controls the electronic device 101 to switch from the first mode to the second mode may occur in case that the channel established between the electronic device 101 and the base station 220 has a low quality. Therefore, the electronic device 101 may control the communication circuitry 330 to transmit a rank indicator to the base station 220 such that the value of the maximum rank supported by the electronic device 101 is configured lower than the actual value. According to an example, the electronic device 101 may transmit a channel state information report (CSI report) including a rank indicator that configures the value of the maximum rank supported by the electronic device 101 to be lower than the actual value to the base station 220. Based on the channel state information report transmitted by the electronic device 101, the base station 220 may identify that the quality between the electronic device 101 and the base station 220 is deteriorated (or poor), and transmit a signal (e.g., an RRC reconfiguration message) for instructing the electronic device 101 to switch from the first mode to the second mode to the electronic device 101. Upon receiving the signal instructing a transition from the first mode to the second mode from the base station 220, the electronic device 101 may switch from the first mode to the second mode, and may transmit one data layer including call-related packets to the base station 220.

The electronic device 101 may transmit call-related packets to the base station 220 via at least one of the plurality of antennas in operation 1150.

In order to transmit call-related packets to the base station 220 via at least one of the plurality of antennas 340, the electronic device 101 may reduce the number of layers of data streams transmitted to the base station 220. The reduced number of layers of data streams transmitted to the base station 220 may refer to a possible reduction in the number of antennas used by the electronic device 101 to transmit signals to the base station 220. Reducing the number of antennas used to transmit signals may reduce the magnitude of a magnetic field generated by a change in signal output. The reduced magnitude of the magnetic field may reduce the interference experienced by the wearable device due to signals output by the electronic device 101.

According to an example, in a situation in which the electronic device 101 performs UL-MIMO via a TDD channel, reducing the number of layers of data streams may reduce the change in strength of signals that are output, thereby reducing the magnitude of the magnetic field.

In response to a transition to the second mode, the electronic device 101 may control the communication circuitry 330 to output a signal including a call-related packet via at least one of the plurality of antennas 340.

According to an example, a call-related packet may be implemented as one data layer and then transmitted to the base station 220. The electronic device 101 may transmit call-related packets via two or more antennas. However, respective signals output via two or more antennas may be configured to include the same data.

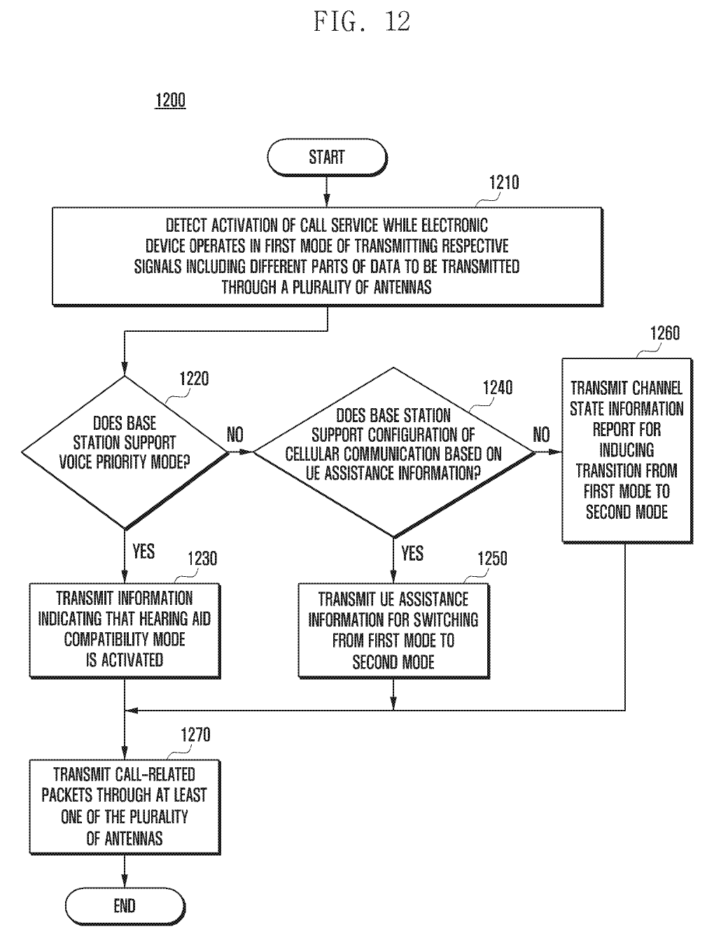

FIG. 12 is a flowchart illustrating an operation method of an electronic device according to an embodiment of the disclosure.

Referring to flowchart 1200 of FIG. 12, the electronic device (for example, the electronic device 101 in FIG. 3) may detect activation of a call service while the electronic device 101 operates in a first mode of transmitting respective signals including different parts of data to be transmitted via a plurality of antennas, in operation 1210.

The electronic device 101 may receive an RRC reconfiguration message from the base station 220 and perform cellular communication using a plurality of antennas 340, based on information related to a signal transmission scheme using a plurality of antennas 340 included in the RRC reconfiguration message.

According to an example, in case that the base station 220 (or the cellular network) supports uplink multiple-input multiple-output (UL-MIMO), the electronic device 101 may receive an RRC reconfiguration message including a configuration related to the UL-MIMO. According to an example, the configuration related to UL-MIMO may include at least one of whether the UL-MIMO is activated, the number of antennas that may be used by the electronic device 101 to transmit signals to the base station 220, or the number of layers (Tx layers) of data to be transmitted by the electronic device 101 to the base station 220.

The electronic device 101 may receive an RRC reconfiguration message including a configuration related to UL-MIMO from the base station 220, and transmit signals via a plurality of antennas 340, based on the configuration related to UL-MIMO. In case that the electronic device 101 performs UL-MIMO, data included in a signal output via one of the plurality of antennas 340 and data included in a signal output via another of the plurality of antennas 340 may differ from each other. The electronic device 101 may improve the data transmission rate (or throughput) by transmitting respective signals including different parts of data to be transmitted to the base station 220 via the plurality of antennas 340.

The electronic device 101 performing UL-MIMO may support various modes according to the number of layers of data transmitted by the electronic device 101. According to an example, the number of layers may refer to the number of individual data streams transmitted in case that the electronic device 101 transmits a plurality of data streams via a plurality of antennas 340. According to an example, the description that the number of layers of data is two may mean that two data streams including different pieces of data may be transmitted via the plurality of antennas 340. A mode for transmitting at least two or more data layers may be defined as a first mode. A mode for transmitting two data layers may be referred to as a spatially multiplexed dual layer (SMDL). A mode for transmitting one data layer may be referred to as a second mode (or spatially multiplexed single layer (SMSL)).

According to an example, the electronic device 101 may perform cellular wireless communication in a first mode (e.g., SMDL) that supports transmission of at least two or more data layers. The electronic device 101 may control the communication circuitry 330 to transmit signals including different pieces of data obtained by dividing data to be transmitted, according to the configured number of layers, to the base station 220 via the plurality of antennas 340.

The electronic device 101 may detect activation of a call service while performing cellular wireless communication in a first mode (e.g., SMDL) supporting transmission of at least two or more data layers.

According to an example, the electronic device 101 may detect activation of a call service according to execution of an application related to the call service. According to another example, the electronic device 101 may detect activation of a call service in response to receiving a signal (e.g., a paging message) indicating activation of a call service from the base station 220.

The electronic device 101 may identify whether a wearable device (e.g., a hearing aid) is adjacent to the electronic device 101 in response to detecting activation of a call service. Alternatively, the electronic device 101 may identify whether the wearable device (e.g., a hearing aid) is likely to be adjacent to the electronic device 101, in response to detecting activation of the call service. The wearable device may refer to various electronic devices that may possibly experience interference in operations of the wearable device by signals output by the electronic device 101 while the electronic device 101 performs a call service. Although a hearing aid is given as a representative example of the wearable device in the disclosure, the wearable device is not limited to a hearing aid, and may refer to various electronic devices that may possibly experience interference by signals output by the electronic device 101 while the electronic device 101 performs a call service.

The electronic device 101 may identify whether the base station supports a voice priority mode in operation 1220.

The electronic device 101 may identify whether the base station 220 supports a voice priority mode in which call-related packets are transmitted with higher priority than other packets. According to an example, the electronic device 101 may receive an RRC reconfiguration message from the base station 220 during a process of initially accessing the base station 220 (e.g., a process in which the electronic device 101 hands over from another base station to the base station 220) or a process of switching the RRC state (e.g., switching from an RRC idle state to an RRC connected state). The RRC reconfiguration message received from the base station 220 may include information indicating whether the base station 220 supports the voice priority mode. The voice priority mode may refer to a mode in which the base station 220 or the electronic device 101 preferentially processes transmission and/or reception of call-related packets, as compared to transmission and/or reception of other types of packets (e.g., packets including user data). The base station 220 supporting the voice priority mode may reduce the delay time of transmission and/or reception of call-related packets as compared to base stations not supporting the voice priority mode.

The electronic device 101 may identify whether the base station 220 supports the voice priority mode, based on information indicating whether the voice priority mode is supported, included in the RRC reconfiguration message received from the base station 220.

In operation 1230, the electronic device 101 may transmit information indicating that the hearing aid compatibility (HAC) mode is activated to the base station 220, in case that the base station supports the voice priority mode (Yes in operation 1220.

In case that the base station 220 supporting the voice priority mode receives a specific signal (e.g., information indicating that the hearing aid compatibility mode is activated) from the electronic device 101, the base station 220 may transmit one data layer to the electronic device 101, when transmitting call-related packets, even if the electronic device 101 is configured to operate in a mode of transmitting a plurality of data layers.

The electronic device 101 may identify whether the base station 220 supports cellular communication based on UE assistance information, in case that the base station supports no voice priority mode (No in operation 1220), in operation 1240.

In case that the hearing aid compatibility mode is activated in the electronic device 101, and in case that the base station 220 does not support the voice priority mode in which call-related packets are transmitted and/or received with higher priority than other packets, the electronic device 101 may identify whether the base station 220 supports configuration of cellular wireless communication based on UE assistance information. According to an example, the electronic device 101 may receive an RRC reconfiguration message from the base station 220 in a process of initially accessing the base station 220 (e.g., a process in which the electronic device 101 hands over from another base station to the base station 220) or in a process of switching the RRC state (e.g., switching from an RRC idle state to an RRC connected state). The RRC reconfiguration message received from the base station 220 may include information indicating whether the base station 220 supports configuration of cellular wireless communication based on UE assistance information.

In operation 1250, the electronic device 101 may transmit UE assistance information for switching from the first mode to the second mode to the base station 220 in case that the base station 220 supports configuration of cellular communication based on the UE assistance information (Yes in operation 1240).

In case that the hearing aid compatibility mode is activated in the electronic device 101, and in case that the base station 220 supports configuration of cellular wireless communication based on UE assistance information, the electronic device 101 may transmit UE assistance information to the base station 220 so as to switch from the first mode to the second mode. As described above, the first mode may refer to a mode (e.g., SMDL) in which signals including different parts of data to be transmitted are transmitted via a plurality of antennas, and the second mode may refer to a mode (e.g., SMSL) in which a signal including data to be transmitted is transmitted via at least one antenna among a plurality of antennas.

The UE assistance information for switching from the first mode to the second mode may be included in a field indicating the maximum number of layers of MIMO among fields included in the UE assistance information (e.g., maximum number of MIMO layers). According to an example, the electronic device 101 may transmit UE assistance information in which the maximum number of MIMO layers is set to1 to the base station 220, thereby inducing the base station 220 to control the electronic device 101 to switch from the first mode to the second mode.

In operation 1260, the electronic device 101 may transmit a channel state information report for inducing a transition from the first mode to the second mode to the base station 220, in case that the base station 220 supports no configuration of cellular communication based on UE assistance information (No in operation 1240).

In case that the hearing aid compatibility mode is activated in the electronic device 101, and in case that the base station 220 supports no configuration of cellular wireless communication based on UE assistance information, the electronic device 101 may perform an operation of inducing the base station 220 to control the electronic device 101 to switch from the first mode to the second mode.

For example, a situation in which the base station 220 controls the electronic device 101 to switch from the first mode to the second mode may occur in case that the quality of a channel established between the electronic device 101 and the base station 220 is low. Therefore, the electronic device 101 may control the communication circuitry 330 to transmit information indicating a quality lower (or worse) than the actual quality of the channel established (or provided/generated) between the electronic device 101 and the base station 220 to the base station 220. According to an example, the electronic device 101 may transmit a channel state information report (CSI report) including information indicating a quality lower (or worse) than the actual quality of the channel established (or provided/generated) between the electronic device 101 and the base station 220 to the base station 220. Based on the channel state information report transmitted by the electronic device 101, the base station 220 may identify that the quality between the electronic device 101 and the base station 220 is deteriorated (or poor), and may transmit, to the electronic device 101, a signal (for example, RRC reconfiguration message) instructing the electronic device 101 to switch from the first mode to the second mode. Upon receiving the signal instructing a transition from the first mode to the second mode from the base station 220, the electronic device 101 may switch from the first mode to the second mode, and may transmit one data layer including call-related packets to the base station 220.

For example, a situation in which the base station 220 controls the electronic device 101 to switch from the first mode to the second mode may occur in case that the channel established between the electronic device 101 and the base station 220 has a low quality. Therefore, the electronic device 101 may control the communication circuitry 330 to transmit a rank indicator to the base station 220 such that the value of the maximum rank supported by the electronic device 101 is configured lower than the actual value. According to an example, the electronic device 101 may transmit a channel state information report (CSI report) including a rank indicator that configures the value of the maximum rank supported by the electronic device 101 to be lower than the actual value to the base station 220. Based on the channel state information report transmitted by the electronic device 101, the base station 220 may identify that the quality between the electronic device 101 and the base station 220 is deteriorated (or poor), and transmit a signal (e.g., an RRC reconfiguration message) for instructing the electronic device 101 to switch from the first mode to the second mode to the electronic device 101. Upon receiving the signal instructing a transition from the first mode to the second mode from the base station 220, the electronic device 101 may switch from the first mode to the second mode, and may transmit one data layer including call-related packets to the base station 220.

The electronic device 101 may transmit call-related packets to the base station 220 via at least one of the plurality of antennas in operation 1270.

In order to transmit call-related packets to the base station 220 via at least one of the plurality of antennas 340, the electronic device 101 may reduce the number of layers of data streams transmitted to the base station 220. The reduced number of layers of data streams transmitted to the base station 220 may refer to a possible reduction in the number of antennas used by the electronic device 101 to transmit signals to the base station 220. Reducing the number of antennas used to transmit signals may reduce the magnitude of a magnetic field generated by a change in signal output. The reduced magnitude of the magnetic field may reduce the interference experienced by the wearable device due to signals output by the electronic device 101.

According to an example, in a situation in which the electronic device 101 performs UL-MIMO via a TDD channel, reducing the number of layers of data streams may reduce the change in strength of signals that are output, thereby reducing the magnitude of the magnetic field.

In response to a transition from the first mode to the second mode, the electronic device 101 may transmit data to the base station 220 via at least one of the plurality of antennas 340. By configuring at least some of the antennas that have been outputting signals in the first mode so as to output no signals, interference applied to the wearable device (or hearing aid) may be reduced (or minimized). Signals transmitted by the electronic device 101 in the second may be transmitted to the base station 220 via a time division duplex channel.

An electronic device according to an embodiment may include a plurality of antennas. The electronic device may include a communication circuitry electrically connected to the plurality of antennas. The electronic device may include memory storing a computer program including instructions. The electronic device may include at least one processor. The instructions, when executed individually or collectively by the at least one processor, may cause the electronic device to detect an activation of call service while transmitting, to a base station, respective signals including different parts of data to be transmitted via the plurality of antennas. The instructions, when executed individually or collectively by the at least one processor, may cause the electronic device to, when hearing aid compatibility mode is activated on the electronic device and the base station supports voice priority mode in which packets related to the call service are transmitted with higher priority than other packets, transmit the packets related to the call service via at least one antenna among the plurality of antennas.

In connection with the electronic device according to an example, the instructions, when executed individually or collectively by the at least one processor, may cause the electronic device to, when the hearing aid compatibility mode is activated on the electronic device and the base station does not support the voice priority mode, cause the base station to switch the electronic device from a first mode to a second mode, wherein the first mode is a mode in which the electronic device transmits the respective signals including different parts of the data to be transmitted via the plurality of antenna, and the second mode is a mode in which the electronic device transmits the data to be transmitted via an antenna among the plurality of antenna.

In connection with the electronic device according to an example, the switching the electronic device from the first mode to second mode may include transmitting, to the base station, a channel state information report indicating that a quality of a channel established between the electronic device and the base station is low.

In connection with the electronic device according to an example, the switching the electronic device from the first mode to second mode may include transmitting, to the base station, a channel state information report indicating that rank indicator being supported by the electronic device is low.

In connection with the electronic device according to an example, the instructions, when executed individually or collectively by the at least one processor, may cause the electronic device to transmitting the respective signals including different parts of the data to be transmitted via the plurality of antenna using time division duplex channel.

In connection with the electronic device according to an example, the instructions, when executed individually or collectively by the at least one processor, may cause the electronic device to, when the hearing aid compatibility mode is activated on the electronic device and the base station does not support the voice priority mode, transmit, to the base station, a request signal for activation of uplink carrier aggregation. The instructions, when executed individually or collectively by the at least one processor, may cause the electronic device to, based on information indicating resource allocation, transmit a part of the data via the time division duplex channel and another part of the data via a frequency division duplex channel.

In connection with the electronic device according to an example, the instructions, when executed individually or collectively by the at least one processor, may cause the electronic device to, when the hearing aid compatibility mode is activated on the electronic device and the base station does not support the voice priority mode, cause the base station to switch the channel between the electronic device and the base station to the frequency division duplex channel.

A computer-readable recording medium may store instructions which, when executed by at least one processor of an electronic device, are executed by the electronic device. The instructions, when executed individually or collectively by the at least one processor, cause the electronic device to detect an activation of call service while transmitting, to a base station, respective signals including different parts of data to be transmitted via the plurality of antennas. The instructions, when executed individually or collectively by the at least one processor, cause the electronic device to, when hearing aid compatibility mode is activated on the electronic device and the base station supports voice priority mode in which packets related to the call service are transmitted with higher priority than other packets, transmit the packets related to the call service via at least one antenna among the plurality of antennas.

In connection with the recording medium according to an example, the instructions, when executed individually or collectively by the at least one processor, may cause the electronic device to, when the hearing aid compatibility mode is activated on the electronic device and the base station does not support the voice priority mode, cause the base station to switch the electronic device from a first mode to a second mode, wherein the first mode is a mode in which the electronic device transmits the respective signals including different parts of the data to be transmitted via the plurality of antenna, and the second mode is a mode in which the electronic device transmits the data to be transmitted via an antenna among the plurality of antenna.

In connection with the recording medium according to an example, the switching the electronic device from the first mode to second mode may include transmitting, to the base station, a channel state information report indicating that a quality of a channel established between the electronic device and the base station is low.

In connection with the recording medium according to an example, the switching the electronic device from the first mode to second mode may include transmitting, to the base station, a channel state information report indicating that rank indicator being supported by the electronic device is low.

In connection with the recording medium according to an example, the instructions, when executed individually or collectively by the at least one processor, may cause the electronic device to transmitting the respective signals including different parts of the data to be transmitted via the plurality of antenna using time division duplex channel.

In connection with the recording medium according to an example, the instructions, when executed individually or collectively by the at least one processor, may cause the electronic device to, when the hearing aid compatibility mode is activated on the electronic device and the base station does not support the voice priority mode, transmit, to the base station, a request signal for activation of uplink carrier aggregation. The instructions, when executed individually or collectively by the at least one processor, may cause the electronic device to, based on information indicating resource allocation, transmit a part of the data via the time division duplex channel and another part of the data via a frequency division duplex channel.

In connection with the recording medium according to an example the instructions, when executed individually or collectively by the at least one processor, may cause the electronic device to, when the hearing aid compatibility mode is activated on the electronic device and the base station does not support the voice priority mode, cause the base station to switch the channel between the electronic device and the base station to the frequency division duplex channel.

A method for operating an electronic device according to an example may include detecting an activation of call service while transmitting, to a base station, respective signals including different parts of data to be transmitted via the plurality of antennas. The method for operating an electronic device may include, when hearing aid compatibility mode is activated on the electronic device and the base station supports voice priority mode in which packets related to the call service are transmitted with higher priority than other packets, transmitting the packets related to the call service via at least one antenna among the plurality of antennas.

The method for operating an electronic device according to an example may include, when the hearing aid compatibility mode is activated on the electronic device and the base station does not support the voice priority mode, causing the base station to switch the electronic device from a first mode to a second mode, wherein the first mode is a mode in which the electronic device transmits the respective signals including different parts of the data to be transmitted via the plurality of antenna, and the second mode is a mode in which the electronic device transmits the data to be transmitted via an antenna among the plurality of antenna.

In connection with the method for operating an electronic device according to an example, the switching the electronic device from the first mode to second mode may include transmitting, to the base station, a channel state information report indicating that a quality of a channel established between the electronic device and the base station is low.

In connection with the method for operating an electronic device according to an example, the switching the electronic device from the first mode to second mode may include transmitting, to the base station, a channel state information report indicating that rank indicator being supported by the electronic device is low.

The method for operating an electronic device according to an example may further include, when the hearing aid compatibility mode is activated on the electronic device and the base station does not support the voice priority mode, transmitting, to the base station, a request signal for activation of uplink carrier aggregation. The method for operating an electronic device may include further include, based on information indicating resource allocation, transmitting a part of the data via the time division duplex channel and another part of the data via a frequency division duplex channel.

The method for operating an electronic device according to an example may further include, when the hearing aid compatibility mode is activated on the electronic device and the base station does not support the voice priority mode, cause the base station to switch the channel between the electronic device and the base station to the frequency division duplex channel.

An electronic device according to an embodiment may include a plurality of antennas. The electronic device may include a communication circuitry electrically connected to the plurality of antennas. The electronic device may include memory storing a computer program including instructions. The electronic device may include at least one processor. The instructions, when executed individually or collectively by the at least one processor, may cause the electronic device to detect an activation of call service while transmitting, to a base station, respective signals including different parts of data to be transmitted via the plurality of antennas. The instructions, when executed individually or collectively by the at least one processor, may cause the electronic device to, when hearing aid compatibility mode is activated on the electronic device and the base station supports configuration of cellular communication based on UE assistance information transmitted by the electronic device, transmit, to the base station, the UE assistance information for switching the electronic device from a first mode in which the electronic device outputs respective signals including different parts of the data to be transmitted via the plurality of antennas to a second mode in which the electronic device outputs the data to be transmitted via one of the plurality of antennas. The instructions, when executed individually or collectively by the at least one processor, may cause the electronic device to transmit the packets related to the call service via at least one antenna among the plurality of antennas.

In connection with the electronic device according to an example, the UE assistance information may be configured such that the maximum number of layers supportable by the electronic device is one.

In connection with the electronic device according to an example, the instructions, when executed individually or collectively by the at least one processor, may cause the electronic device to, when the hearing aid compatibility mode is activated in the electronic device and the base station does not support configuration of cellular communication based on UE assistance information transmitted by the electronic device, cause the base station to switch the electronic device from the first mode to the second mode.

In connection with the electronic device according to an example, the switching the electronic device from the first mode to second mode may include transmitting, to the base station, a channel state information report indicating that a quality of a channel established between the electronic device and the base station is low.

In connection with the electronic device according to an example, the switching the electronic device from the first mode to second mode may include transmitting, to the base station, a channel state information report indicating that rank indicator being supported by the electronic device is low.

In connection with the electronic device according to an example, the instructions, when executed individually or collectively by the at least one processor, may cause the electronic device to, when the hearing aid compatibility mode is activated on the electronic device and the base station does not support configuration of cellular communication based on UE assistance information transmitted by the electronic device, transmit, to the base station, a request signal for activation of uplink carrier aggregation. The instructions, when executed individually or collectively by the at least one processor, may cause the electronic device to, based on information indicating resource allocation, transmit a part of the data via the time division duplex channel and another part of the data via a frequency division duplex channel.

In connection with the electronic device according to an example, the instructions, when executed individually or collectively by the at least one processor, may cause the electronic device to, when the hearing aid compatibility mode is activated on the electronic device and the base station does not support configuration of cellular communication based on UE assistance information transmitted by the electronic device, cause the base station to switch the channel between the electronic device and the base station to the frequency division duplex channel.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a plurality of antennas;
communication circuitry electrically connected to the plurality of antennas;
memory storing a computer program including instructions; and
at least one processor,
wherein the instructions, when executed individually or collectively by the at least one processor, cause the electronic device to:
detect an activation of call service while transmitting, to a base station, respective signals including different parts of data to be transmitted via the plurality of antennas, and
when a hearing aid compatibility mode is activated on the electronic device and the base station supports a voice priority mode in which packets related to the call service are transmitted with higher priority than other packets, transmit the packets related to the call service via at least one antenna among the plurality of antennas.

2. The electronic device of claim 1, wherein the instructions, when executed individually or collectively by the at least one processor, cause the electronic device to:
when the hearing aid compatibility mode is activated on the electronic device and the base station does not support the voice priority mode, cause the base station to switch the electronic device from a first mode to a second mode; and
wherein the first mode is a mode in which the electronic device transmits the respective signals including different parts of the data to be transmitted via the plurality of antennas, and the second mode is a mode in which the electronic device transmits the data to be transmitted via an antenna among the plurality of antennas.

3. The electronic device of claim 2, wherein the switching of the electronic device from the first mode to second mode includes transmitting, to the base station, a channel state information report indicating that a quality of a channel established between the electronic device and the base station is low.

4. The electronic device of claim 3, wherein the switching of the electronic device from the first mode to second mode includes transmitting, to the base station, a channel state information report indicating that rank indicator being supported by the electronic device is low.

5. The electronic device of claim 1, wherein the instructions, when executed individually or collectively by the at least one processor, cause the electronic device to transmitting the respective signals including different parts of the data to be transmitted via the plurality of antennas using a time division duplex channel.

6. The electronic device of claim 5, wherein the instructions, when executed individually or collectively by the at least one processor, cause the electronic device to:
when the hearing aid compatibility mode is activated on the electronic device and the base station does not support the voice priority mode, transmit, to the base station, a request signal for activation of uplink carrier aggregation; and
based on information indicating resource allocation, transmit a part of the data via the time division duplex channel and another part of the data via a frequency division duplex channel.

7. The electronic device of claim 6, wherein the instructions, when executed individually or collectively by the at least one processor, cause the electronic device to:
when the hearing aid compatibility mode is activated on the electronic device and the base station does not support the voice priority mode, cause the base station to switch the channel between the electronic device and the base station to the frequency division duplex channel.

8. One or more non-transitory computer-readable storage media storing one or more computer programs including computer-executable instructions that, when executed by one or more processors of an electronic device, individually or collectively, cause the electronic device to perform operations, the operations comprising:
detecting an activation of call service while transmitting, to a base station, respective signals including different parts of data to be transmitted via a plurality of antennas; and
when a hearing aid compatibility mode is activated on the electronic device and the base station supports a voice priority mode in which packets related to the call service are transmitted with higher priority than other packets, transmitting the packets related to the call service via at least one antenna among the plurality of antennas.

9. The one or more non-transitory computer-readable storage media of claim 8, wherein the instructions, when executed individually or collectively by the at least one processor, cause the electronic device to:
when the hearing aid compatibility mode is activated on the electronic device and the base station does not support the voice priority mode, cause the base station to switch the electronic device from a first mode to a second mode; and
wherein the first mode is a mode in which the electronic device transmits the respective signals including different parts of the data to be transmitted via the plurality of antennas, and the second mode is a mode in which the electronic device transmits the data to be transmitted via an antenna among the plurality of antennas.

10. The one or more non-transitory computer-readable storage media of claim 9, wherein the switching of the electronic device from the first mode to second mode includes transmitting, to the base station, a channel state information report indicating that a quality of a channel established between the electronic device and the base station is low.

11. The one or more non-transitory computer-readable storage media of claim 10, wherein the switching of the electronic device from the first mode to second mode includes transmitting, to the base station, a channel state information report indicating that rank indicator being supported by the electronic device is low.

12. The one or more non-transitory computer-readable storage media of claim 8, wherein the instructions, when executed individually or collectively by the one or more processors, cause the electronic device to transmitting the respective signals including different parts of the data to be transmitted via the plurality of antennas using a time division duplex channel.

13. The one or more non-transitory computer-readable storage media of claim 12, wherein the instructions, when executed individually or collectively by the one or more processors, cause the electronic device to:
when the hearing aid compatibility mode is activated on the electronic device and the base station does not support the voice priority mode, transmit, to the base station, a request signal for activation of uplink carrier aggregation; and
based on information indicating resource allocation, transmit a part of the data via the time division duplex channel and another part of the data via a frequency division duplex channel.

14. The one or more non-transitory computer-readable storage media of claim 13, wherein the instructions, when executed individually or collectively by the one or more processors, cause the electronic device to:
when the hearing aid compatibility mode is activated on the electronic device and the base station does not support the voice priority mode, cause the base station to switch the channel between the electronic device and the base station to the frequency division duplex channel.

15. A method for operating an electronic device, the method comprising:
detecting an activation of call service while transmitting, to a base station, respective signals including different parts of data to be transmitted via a plurality of antennas; and
when a hearing aid compatibility mode is activated on the electronic device and the base station supports a voice priority mode in which packets related to the call service are transmitted with higher priority than other packets, transmitting the packets related to the call service via at least one antenna among the plurality of antennas.

16. The method of claim 15, further comprising:
when the hearing aid compatibility mode is activated on the electronic device and the base station does not support the voice priority mode, causing the base station to switch the electronic device from a first mode to a second mode; and
wherein the first mode is a mode in which the electronic device transmits the respective signals including different parts of the data to be transmitted via the plurality of antennas, and the second mode is a mode in which the electronic device transmits the data to be transmitted via an antenna among the plurality of antennas.

17. The method of claim 16, wherein the switching of the electronic device from the first mode to second mode includes transmitting, to the base station, a channel state information report indicating that a quality of a channel established between the electronic device and the base station is low.

18. The method of claim 17, wherein the switching of the electronic device from the first mode to second mode includes transmitting, to the base station, a channel state information report indicating that rank indicator being supported by the electronic device is low.

19. The method of claim 15, further comprising:
when the hearing aid compatibility mode is activated on the electronic device and the base station does not support the voice priority mode, transmitting, to the base station, a request signal for activation of uplink carrier aggregation; and
based on information indicating resource allocation, transmitting a part of the data via a time division duplex channel and another part of the data via a frequency division duplex channel.

20. The method of claim 19, further comprising:
when the hearing aid compatibility mode is activated on the electronic device and the base station does not support the voice priority mode, cause the base station to switch the channel between the electronic device and the base station to the frequency division duplex channel.

21. An electronic device comprising:
a plurality of antennas;
communication circuitry electrically connected to the plurality of antennas;
memory storing a computer program including instructions; and
at least one processor,
wherein the instructions, when executed individually or collectively by the at least one processor, cause the electronic device to:
detect an activation of call service while transmitting, to a base station, respective signals including different parts of data to be transmitted via the plurality of antennas,
when a hearing aid compatibility mode is activated on the electronic device and the base station supports configuration of cellular communication based on user equipment (UE) assistance information transmitted by the electronic device, transmit, to the base station, the UE assistance information for switching the electronic device from a first mode in which the electronic device outputs respective signals including different parts of the data to be transmitted via the plurality of antennas to a second mode in which the electronic device outputs the data to be transmitted via one of the plurality of antennas, and
transmit packets related to the call service via at least one antenna among the plurality of antennas.

22. The electronic device of claim 21, wherein the UE assistance information is configured such that the maximum number of layers supportable by the electronic device is one.

23. The electronic device of claim 21, wherein the instructions, when executed individually or collectively by the at least one processor, cause the electronic device to:
when the hearing aid compatibility mode is activated in the electronic device and the base station does not support configuration of cellular communication based on UE assistance information transmitted by the electronic device, cause the base station to switch the electronic device from the first mode to the second mode.

24. The electronic device of claim 21, wherein the switching the electronic device from the first mode to second mode includes transmitting, to the base station, a channel state information report indicating that a quality of a channel established between the electronic device and the base station is low.

25. The electronic device of claim 21, wherein the switching the electronic device from the first mode to second mode includes transmitting, to the base station, a channel state information report indicating that rank indicator being supported by the electronic device is low.

26. The electronic device of claim 21, wherein the instructions, when executed individually or collectively by the at least one processor, cause the electronic device to:
when the hearing aid compatibility mode is activated on the electronic device and the base station does not support configuration of cellular communication based on UE assistance information transmitted by the electronic device, transmit, to the base station, a request signal for activation of uplink carrier aggregation; and
based on information indicating resource allocation, transmit a part of the data via a time division duplex channel and another part of the data via a frequency division duplex channel.

27. The electronic device of claim 26, wherein the instructions, when executed individually or collectively by the at least one processor, cause the electronic device to:
when the hearing aid compatibility mode is activated on the electronic device and the base station does not support configuration of cellular communication based on UE assistance information transmitted by the electronic device, cause the base station to switch the channel between the electronic device and the base station to the frequency division duplex channel.

28. The electronic device of claim 23,
wherein the first mode is a spatially multiplexed dual layer (SMDL) mode for transmitting two or more data layers, and
wherein the second mode is a spatially multiplexed single layer (SMSL) mode for transmitting a single data layer.

29. The electronic device of claim 28, wherein when the hearing aid compatibility mode is activated on the electronic device and the base station does not support configuration of cellular communication based on UE assistance information transmitted by the electronic device, the electronic device reduces a magnitude of a magnetic field generated by output of signals via the plurality of antennas thereby reducing or preventing interference of a wearable device by switch from the first mode to the second mode.
